(19) United States
(12) Patent Application Publication
(10) Pub. No.: US 2003/0167183 A1
(43) Pub. Date: Sep. 4, 2003

(54) Volunteer activity/business activity supporting method

(76) Inventors: Kunihiko Kido, Sagamihara (JP); Tetsuo Tanaka, Yamato (JP); Koichi Haruna, Yokohama (JP); Toshiharu Kato, Musashino (JP); Masahiro Hanada, Kuriyama (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/291,367

(22) Filed: Nov. 12, 2002

(30) Foreign Application Priority Data
Mar. 1, 2002 (JP) 2002-056068

(51) Int. Cl. G06F 17/60

(52) U.S. Cl. 705/1

(57) ABSTRACT

An introduction service is supported to activate and smoothen a community activity and a business activity. A coordinator terminal 2 retrieves the provided service information matching the site providing offer of the business activity designated by a coordinator, and each of participants specified with the detected information is selected as an introduced candidate for the site providing offer. There is displayed an introduced candidate list in which the personal information and desire of each introduced candidate are described.

### CROSS-REFERENCE TO RELATED APPLICATION

This application is related to co-pending patent application Ser. No. 09/942,801, which is hereby incorporated by reference in its entirety.

### BACKGROUND OF THE INVENTION

The present invention relates to a technology for supporting the co-creation to be realized through a volunteer activity premising the mutual rewards such as the Eco Money activity and the coexistence/mutual prosperity of the collaboration to be realized through a business activity such as a regional business. More particularly, the invention relates to a technology for supports to introduce a provider capable of providing services (containing provisions of goods or other contents) along the desire of an applicant and to enable the provider to acquire a further activity site.

In the prior art, there have been done introduction services for introducing contents along the desire of a user by using a network such as the Internet. One of these introduction services is exemplified by a search engine. This search engine detects a URL (Uniform Resource Locator) of a Web page associated with a search condition identical to or similar to the search condition received from the terminal of a user through the network, from a search database stored being associated with search conditions, and presents link information on the URL to the terminal of the user. By selecting the link information, this user is enabled to get access to the URL specified by that link information and to browse the Web page.

In order to promote the direct business of goods or services between the network participants, there are the services for providing an auction function through the network. A matching between a seller and a buyer can be acquired on the goods or services to be bargained, by the auction based on the bidding prices.

### SUMMARY OF THE INVENTION

In recent years, a necessity for a structure capable of providing participants in a community activity with chances to give and take services has grown higher and higher for activating and smoothening interchanges on an individual basis (as will be called the “community activity”) such as a volunteer activity or a regional activity. In that structure, more specifically, it is possible to introduce to a participant who desires to receive a service (as will be called “applicant”), a different participant capable of providing the service along the desire of the applicant (as will be called “provider”).

Moreover, in order to stimulate the provider and make the community activity more active, it is important to provide the provider with the opportunities for entering a business activity such as supporting business or giving a chance for employment or in other various activities. Moreover, the community activity acts as a mediator to smoothen the human migrations between different kinds of activities. In order to enhance a possibility for the provider to successfully enter the business activity or the like, it is important to provide the provider having a service quality ensured to a certain level with an opportunity to participate in the business activity or the like.

However, these points have been considered neither in the conventional introducing services such as the search engine nor in the auction using the network. It is, therefore, undesirable to incorporate the auction using the conventional introducing services or networks, as they are, into a structure for mediation, such as providing a participant of the community activity with an opportunity to give and take services or an opportunity to enter the business activity or the like.

The present invention has been conceived in view of the background thus far described and has an object to support the co-creation to be realized through a volunteer activity such as the Eco Money activity, and the coexistence mutual prosperity of the collaboration to be realized through a business activity such as a regional business.

In other words, the invention contemplates to provide a structure, in which a person or an organization desiring to provide its own power voluntarily for others can be utilized in society, that is, the structure in which the person or organization can be effectively utilized in a society from the standpoint of the weak, without following a theory of the strong.

For example, the present invention supports mediation between a provider and an activity supporter who provides a site for a business activity or the like, so that it is possible to give a provider an opportunity to enter the business activity or the like. Here, the provider is exemplified by one who has improved services through: mutual helping activities of residents for the services not covered by the nursing care insurance; activities to give the aged an instruction how to use the Internet; exchanges between a school and a community, such as a cooperation by the residents to develop information technology (IT) in the school; a ground work for the residents to participate in; recycling activities; activities of town cleaning and the like; volunteer activity supports by a shopping mall, such as donation of discount; or activities to remake Eco Forests by promoting the exchanges between the residents of urban and mountainous regions.

Here, the invention can be widely applied not only to the volunteer services but also to net transactions of services or goods which cannot be uniquely reduced to the price information, i.e., the services or goods based on the multiple values. The invention can also be applied to the net transactions of the services or goods accompanied by the mutual rewards (in which the services exchanges can be made between the participants such that the applicant becomes a provider to provide services to a different applicant). Moreover, the invention can also be applied to a personal management for researchers, so as to decide a participation in a project within an organization such as an enterprise.

In order to solve the above-specified problems, the present invention contemplates to provide a volunteer activity/business activity supporting method for supporting the volunteer activity and the business activity through a network connected with a plurality of information processing devices.

Specifically, the information processing device for a coordinator connected with the network stores evaluation information of a service provision (containing provisions of goods or other contents) by a volunteer activity, in a storage area over the network in relation to provider information and a service provision desired condition of a service provider.

Moreover, the information processing device for the coordinator responds to a site providing offer of a business activity from an activity supporter, refers to the service provision desired condition and the evaluation information of the service provider stored in the storage area, and outputs the service provision corresponding to the service provision desired condition satisfying at least a portion of the contents of the site providing offer, to the information processing device for the activity supporter, as connected the network.

In order to solve the above-specified problems, moreover, the invention supports the coordinator by using the network system connected with a plurality of terminals through the network, so that a service provider satisfying the desire of an activity supporter for providing the site of activity (or an opportunity for entering the business activity or another activity) may be introduced to the activity supporter.

For example, the terminal of the provider accepts the desired condition on the service provision, that is, the service provision desired condition (for designating a kind of a providable service, a desired date of the service provision or a desired place of the service provision) from the provider, and registers the condition in a manner to correspond to the information of said provider (as will be called the “provider information”).

On the other hand, the terminal of the activity supporter receives the site providing offer of activity (for employees' recruitment, for calling a participation in a project or for accepting an application to use of the Web site as a transaction window, etc.) from the activity supporter, and registers the site providing offer in a manner to correspond to the information of the activity supporter (as will be called the “activity supporter information”).

When one of the registered site providing offers is selected by the coordinator, moreover, the terminal of the coordinator selects such one of the service provision desired condition registered for the selected site providing offer as satisfies at least a portion of the contents of the site providing offer, and selects the providers specified with the provider information corresponding to the contents of the site providing offer, individually as the introduced candidates for the activity supporter. Then, the coordinator terminal presents the introduced candidate list describing the providers information of each of the selected provider and skill information on the quality of the service provision, to the coordinator.

As a result, the coordinator is enabled, by referring to the service desired condition and the skill information of each of the introduced candidates described in the introduced candidate list, to select one introduced candidate who is satisfying the contents of the site providing offer of the activity supporter to some extent and warranting the quality of the services to some extent (or having a high service evaluation), as the provider to be introduced to the activity supporter.

Next, when the terminal of the coordinator receives from the coordinator a selection of the provider to be introduced to the activity supporter out of the introduced candidates described in the introduced candidate list, the terminal of the coordinator outputs the provider information of the provider to the terminal of the activity supporter having done the selected site providing offer.

Therefore, the activity supporter can receive the introduction of a provider of high quality.

According to the present invention, the provider provides services to an applicant as a community activity (i.e., non-business activity), while the activity supporter provides a site of the business activity or a different activity to the provider, whereby the provider is enabled to acquire a site of a new activity such as the business activity by utilizing the experiences obtained in the community activity. According to the present invention, more specifically, the community activity can act as a mediator to smoothen the human migration among different kinds of activities, thereby to support the co-creation to be realized through the volunteer activity such as the Eco Money action and the coexistence/mutual prosperity of the collaboration to be realized through the business activity such as the regional business.

### BRIEF DESCRIPTION OF THE DRAWINGS

FIG. 1 is a diagram showing a schematic configuration of an introduction service supporting system, to which a first embodiment of the invention is applied;

FIG. 2 is a diagram for schematically explaining an introduction service to be done by using the introduction service supporting system shown in FIG. 1;

FIG. 3 is a diagram showing a schematic configuration of each of terminals 1 to 4 shown in FIG. 1;

FIG. 4 presents diagrams showing examples of the registered contents of a community/service management file 1411 shown in FIG. 3;

FIG. 5 is a diagram showing an example of the registered contents of a personal information management file 1412 shown in FIG. 3;

FIG. 6 is a diagram showing an example of the registered contents of a member definition file 1413 shown in FIG. 3;

FIG. 7 is a diagram showing an example of the registered contents of a shared contents file 1414 shown in FIG. 3;

FIG. 8 is a diagram showing an example of the registered contents of provided service information file 1421 shown in FIG. 3;

FIG. 9 is a diagram showing an example of the registered contents of a user management file 1441 shown in FIG. 3;

FIG. 10 is a diagram showing an example of the registered contents of an application/offer management file 1442 shown in FIG. 3;

FIG. 11 is a diagram showing an example of the registered contents of a matching prime plan candidate management file 1443 shown in FIG. 3;

FIG. 12 is a diagram showing an example of the registered contents of a matching prime plan management file 1444 shown in FIG. 3;

FIG. 13 is a diagram showing an example of the registered contents of a negotiation management file 1445 shown in FIG. 3;

FIG. 14 is a diagram showing an example of the registered contents of an execution result management file 1446 shown in FIG. 3;

FIG. 15 is a diagram showing a hardware configuration example of each of the terminals 1 to 4 shown in FIG. 1;

FIG. 16 is a diagram for explaining registration processings of participation in a community activity in one embodiment of the invention;

FIG. 17 is a diagram showing one example of a start menu screen displayed at the terminals 1 to 4;

FIG. 18 is a diagram showing one example of a participation registration screen displayed at the participation terminal 1;

FIG. 19 is a diagram for explaining a registration processing of provided services in one embodiment of the invention;

FIG. 20 is a diagram showing one example of a participant menu screen displayed at the participant terminal 1;

FIG. 21 is a diagram showing one example of a provided service registration screen displayed at the participant terminal 1;

FIG. 22 is a diagram showing one example of a matching prime plan selecting menu screen displayed at the coordinator terminal 2;

FIG. 23 is a diagram showing one example of a community activity introducing service menu screen displayed at the coordinator terminal 2;

FIG. 24 is a diagram for explaining registration processings of execution result reports of community activity introducing services in one embodiment of the invention;

FIG. 25 is a diagram showing an example of the result report screen of the community activity introduction services displayed at the participant terminal 1;

FIG. 26 is a diagram for explaining skill evaluation registration processings in one embodiment of the invention;

FIG. 27 is a diagram showing an example of a skill registration screen displayed at the coordinator terminal 2;

FIG. 28 is a diagram for explaining registration processings of a site providing offer in one embodiment of the invention;

FIG. 29 is a diagram showing an example of the activity supporter menu screen displayed at the supporter terminal 3;

FIG. 30 is a diagram showing an example of the site providing offer registration screen displayed at the supporter terminal 3;

FIG. 31 is a diagram for explaining a creation support/registration processing of a matching prime plan for the business activity introducing services in one embodiment of the invention;

FIG. 32 is a diagram showing one example of a business activity introducing service matching prime menu screen displayed at the coordinator terminal 2;

FIG. 33 is a diagram showing one example of a site providing offer list screen displayed at the coordinator terminal 2;

FIG. 34 is a diagram showing one example of a business activity introducing service matching prime plan creation screen displayed at the coordinator terminal 2;

FIG. 35 presents diagrams for explaining a presentation of the matching prime plan for the business activity introducing services and a registration processing of the execution result report in one embodiment of the invention; and

FIG. 36 is a diagram showing one example of a business activity introducing service matching prime plan/result report screen displayed at the supporter terminal 3.

### DETAILED DESCRIPTION OF THE PREFERRED EMBODIMENTS

The embodiments of the invention will be described on the cases of a support of introducing services between participants who participate in a community activity for exchanging voluntary services (or volunteer services), and a support of introducing services to introduce a participant (or a provider) for providing services, a quality of which has been improved through the community activity, to an activity supporter who provides a site of a business activity or a different activity.

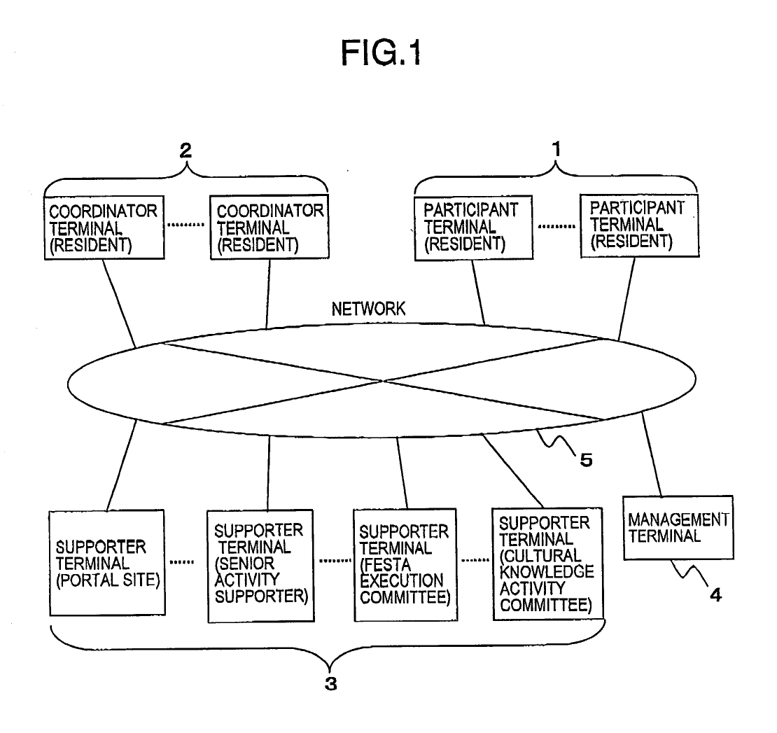

FIG. 1 is a diagram showing a schematic configuration of an introduction service supporting system, to which one embodiment of the invention is applied.

As shown in the Figure, in the configuration of the introduction service supporting system of this embodiment, a participant terminal 1 to be used by a participant to participate in a community activity for exchanging volunteer services, a coordinator terminal 2 to be used by a coordinator, a supporter terminal 3 to be used by an activity supporter for providing the participant in the community activity with an opportunity (or a site) for entering a business activity or a different activity, and a management terminal 4 are connected with one another through a network 5 such as the internet.

The participant in the community activity is conditioned to belong to at least any one community. Here, the community is a group or a base community for the community activity of the participant. The community may have any unit. For example, the community maybe provided at an area unit such as Area A or Area B. Alternatively, the community may be provided at a genre unit such as nursing cares, lifelong learning or personal lessons. Moreover, there may be a mixture of the communities of the area unit and the communities of the genre unit.

For each community, there is assigned at least one coordinator. This coordinator does the works (as will be called the “community activity introducing services”). These works are to select a participant (or a provider) capable of providing services satisfying a desire of a participant (or a use applicant) having applied for a use, from the participants belonging to a community taken under his or her charge, and to perform their mediations (or introductions).

Moreover, the coordinator also does the works (as will be called the “business activity introducing services”) to select a participant capable of providing the services relating to a site provided by an activity supporter, from the participants belonging to the community taken under his or her charge, and to perform their mediations (or introductions).

Here, the site provided by the activity supporter may be, for example, an opportunity-to take employment in an enterprise if the activity supporter is the enterprise, or an allowance or the like of a link with a Web portal site in a home page (i.e., an antenna shop) for the provider to receive a use application of a service as a business (not the volunteer activity), if the activity supporter is an operator of the Web portal site and the like. If the activity supporter is an NPO or NGO type organization, such as a cultural knowledge activity committee or a Festa execution committee, the site may be an opportunity to participate in that organization.

In the aforementioned definitions, the community activity introducing services and the business activity introducing services may be taken under the charges of different coordinators or under the charge of a common coordinator.

Next, here will be schematically described the introducing services to be done by using the introduction service supporting system of the configuration thus far described.

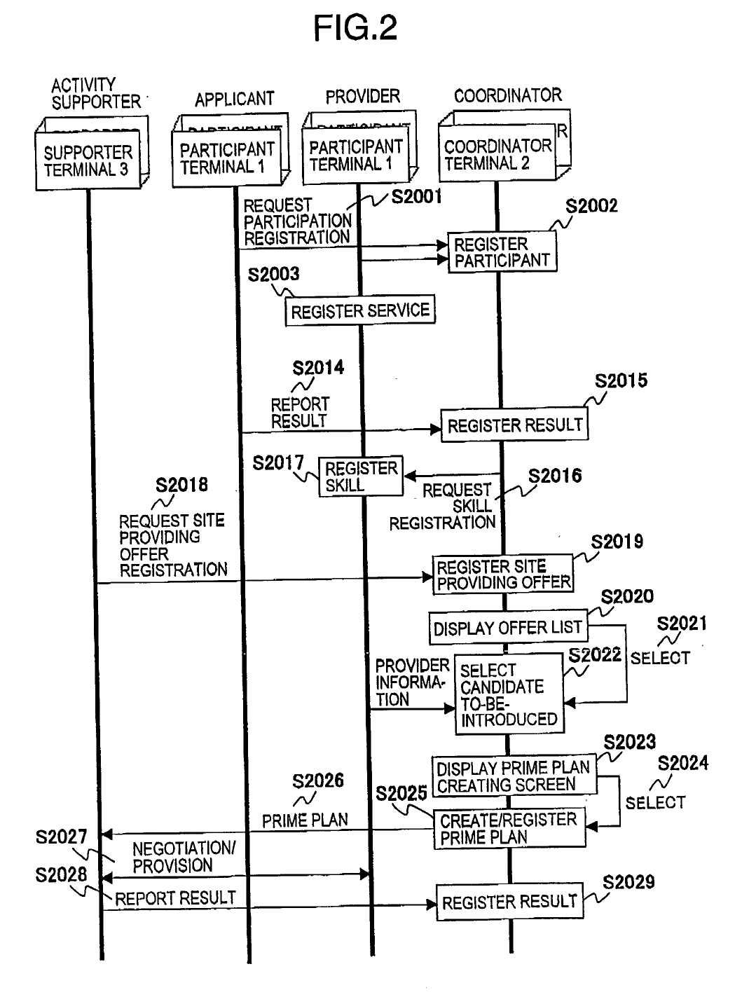

FIG. 2 is a diagram for schematically explaining an introduction service to be done by using the introduction service supporting system as shown in FIG. 1.

In the following description, each coordinator terminal 2 shares various pieces of registered information (containing node information, personal information, use application information and site providing offer information, as will be described in the following).

As shown in the figure, a person desiring to participate in the community activity requests the coordinator terminal 2 for a participation registration by using the participant terminal 1 (S2001), and transmits the personal information containing name, contact information (e.g., address, telephone number and mail address, etc.) and name of the community desired for the participation, and the number of tickets possessed. In response to this, the coordinator terminal 2 generates and registers a user ID, creates a personal information management file of the requester, and it is notified to the participant terminal 1 of the requester (S2002). As a result, the requester can use the community activity introducing services as a participant in the community activity.

Here, the tickets can be used for payment against the volunteer services and exemplified by “Eco Money”, “LETS” or “time-dollar”.

Now, the participant having finished the participation registration uses the participant terminal 1 to register the information, place and time of the providable services as the provided service information (S2003), if he or she desires to provide volunteer services.

On the other hand, the use applicant uses the participant terminal 3 to report, as to the matching prime plan presented by the coordinator terminal 2, the execution results containing the result of the negotiations with the provider, the sum of the tickets paid for the services enjoyed, and the evaluations of the contents of the services enjoyed (S2014). In response to this report, the coordinator terminal 2 registers the execution result received by the use applicant(S2015). Moreover, the ticket payment contained in the execution result is Subtracted from the sum of possessed tickets of the use applicant and added to the sum of possessed tickets of the provider.

On the other hand, the coordinator uses the coordinator terminal 2 to evaluate the skills (or levels) on the services of the provider based on the execution results containing the evaluations on the service contents of the provider. Then, the participant terminal 1 of the provider is requested for the skill registration (S2016). In response to this request, the participant terminal 1 of the provider makes a registration so as to clarify the correspondence between the skill information received from the coordinator terminal 2 and the target services (S2017). When the skill information is registered, the participant can use the business activity introducing services.

Now, the activity supporter uses the supporter terminal 3 to offer a site provision (S2018) to the coordinator terminal 2 taking the charge of the community to be supported, and transmits a mode of the providable site (e.g., recruiting of an employee or an allowance of the link with the Web portal site, etc.) and a type of service together with the information on the activity supporter. The coordinator terminal 2 registers these pieces of information as the site providing offer information (S2019).

In accordance with an instruction of the coordinator, the coordinator terminal 2 presents a site providing offer list describing the site providing offer information that is registered (S2020). When the coordinator selects any site providing offer information from that list (S2021), the coordinator terminal 2 selects a candidate (or a candidate to-be-introduced) of the provider to be introduced to the activity supporter having offered the provision of the selected site providing offer information (S2022).

More specifically, from the provided service information registered at each participant terminal 1 of the community under the charge of the coordinator, there is retrieved the provided service information satisfying at least a portion of the contents of the provided offer information selected, to select a participant of the participant terminal 1 registered with the provided service information detected, as a candidate to-be-introduced.

When the introduced candidate to-be-introduced is thus selected, the coordinator terminal 2 creates and registers a matching prime plan candidate which can specify the candidate to-be-introduced list describing the provided service information and the skill information of each selected candidate to-be-introduced, as well as the site providing offer information of the activity supporter, and presents the coordinator a prime plan creating screen created on the basis of the matching prime plan candidate (S2023).

As a result, the coordinator is enabled, by comparing the site providing offer information and various pieces of information of the individual candidates to-be-introduced contained in the candidate to-be-introduced list, to select a candidate to-be-introduced (or the introduced) satisfying the desire of the activity supporter best, out of the individual candidates to-be-introduced.

If the candidates who satisfy the desire of the activity supporter exist in plural, a candidate to-be-introduced of a high service quality can be selected by comparing the pieces of skill information of those candidates. Therefore, the business activity introducing services can be supported in such a manner that the participant having improved the service quality through the volunteer activity may be introduced as an introduced person to the activity supporter.

When the coordinator uses the coordinator terminal 2 to select the introduced person (S2024) from the candidates to-be-introduced described in the candidate to-be-introduced list, the coordinator terminal 2 creates and registers the matching prime plan capable of specifying the introduced person information and the site providing offer information (S2025). Then, the matching prime plan thus created is presented to the supporter terminal 3 having done the site providing offer (S2026).

The activity supporter communicates and negotiates with the participant (or the introduced person) displayed in the prime plan screen. If the negotiation is completed, the participant is provided with the site of the business activity or a different activity site (S2027). Then, the activity supporter uses the supporter terminal 3 to report the execution result containing the result of the negotiation with the introduced person and the evaluation on the introduced person, as to the matching prime plan which has been presented by the coordinator terminal 2 (S2028). In response to this report, the coordinator terminal 2 registers the execution result received from the supporter terminal 3 (S2029).

Thus, the participant having improved the skills through the volunteer activity is enabled to participate in the business activity or a different activity site by utilizing the experience acquired through the community activity. In short, the human interchanges between the different kinds of activities can be smoothed through the community activity.

Next, here will be described the individual terminals 1 to 4 which are used in the introduction service supporting system of this embodiment.

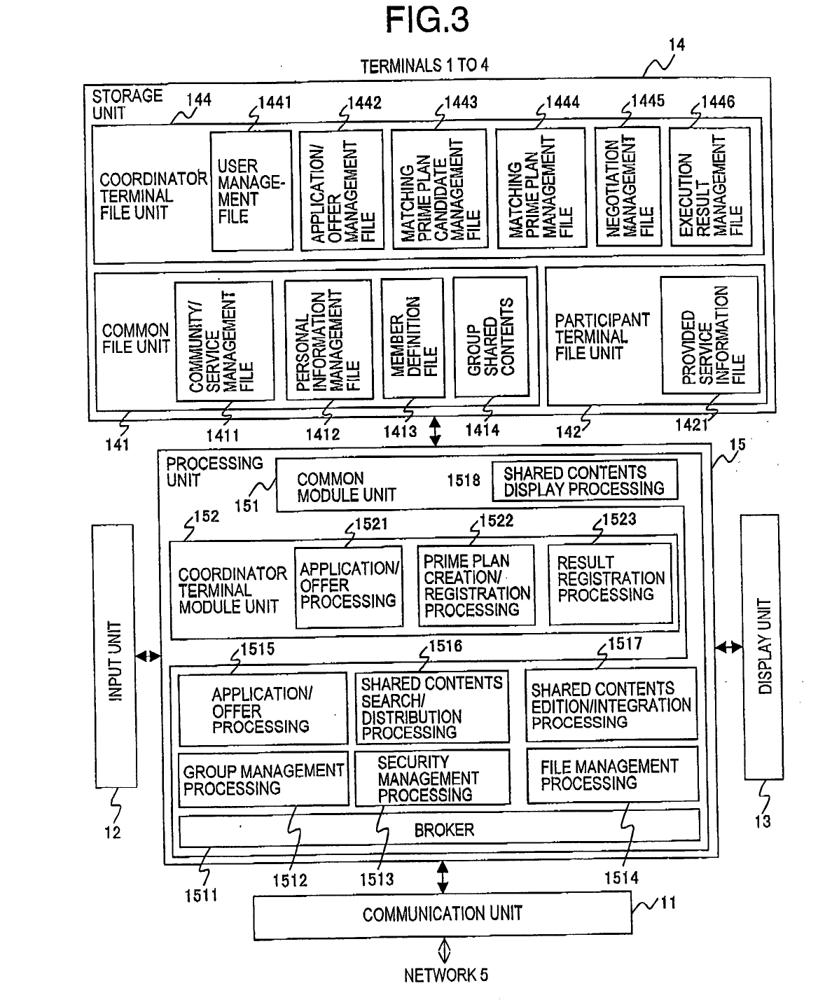

FIG. 3 is a diagram showing a schematic configuration of each of the terminals 1 to 4.

As shown in the Figure, each of the terminals 1 to 4 includes: a communication unit 11 for communicating with other terminals through the network 5; an input unit 12 for receiving the input of an instruction and information from the operator; a display unit 13 for presenting information to the user; a processing unit 15 for supporting the operations of the user; and a storage unit 14 for storing the data to be handled by the processing unit 15.

In the processing unit 15, a common module unit 151 is a processing module group commonly possessed by respective terminals 1 to 4.

Here, a broker 1511 mediates the communications between the individual processing modules mounted on its own terminals 1 to 4 and the individual processing modules mounted on the remaining terminals 1 to 4. Further, a group management processing module 1512 manages the communications between the terminals 1 to 4 of an arbitrary group, such as the communications among the participant terminals 1 belonging to the same community. Here in this embodiment, the communications among the terminals 1 to 4 are implemented by the P2P (Peer To Peer), and the group management processing module 1512 manages the communications among the terminals 1 to 4 of an arbitrary group by the P2P. Further a security management processing module 1513 manages the security in the communications with the remaining terminals 1 to 4. Moreover, a file management processing module 1514 manages an access control to the later-described various files stored in the storage unit 14.

Next, an application/offer processing module 1515 processes the application/offer to be transmitted to the remaining terminals 1 to 4 and the application/offer received from the remaining terminals 1 to 4. Further, a shared contents search/distribution processing module 1516 performs the search processing of the shared contents held by the remaining terminals 1 to 4 and the distribution processing of the shared contents held by itself. Further, a shared contents edition/integration processing module 1517 performs edition processing of the shared contents held by itself and processing for integrating the shared contents held by the individual terminals 1 to 4 of an arbitrary group such as a common community (i.e., processing for causing the individual terminals 1 to 4 of an arbitrary group to share the same contents). Moreover, a shared contents display processing module 1518 displays the shared contents which are integrated by the shared contents edition/integration processing module 1517.

In the processing unit 15, a coordinator terminal module unit 152 is an essential processing module group for the coordinator terminal 2. On the other hand, the coordinator terminal module unit 152 is not essential for the participant terminal 1, the supporter terminal 3 and the management terminal 4.

Here, an application/offer processing module 1521 processes the application/offer to be transmitted to the remaining terminals 1 to 4 and the application/offer received from the remaining terminals 1 to 4. Further, a prime plan creation/registration processing module 1522 registers a matching prime plan candidate for supporting the matching prime plan creation by the coordinator and a matching prime plan created by the coordinator. Moreover, a result registration processing module 1523 registers the execution results for the matching prime plan created by the coordinator.

Next, at the storage unit 14, a common file unit 141 is a file group commonly possessed by respective terminals 1 to 4 and stores a community/service management file 1411, a personal information management file 1412, a member definition file 1413 and a shared contents file 1414. These files are described with the tag format using the XML (eXtensible Markup Language), for example.

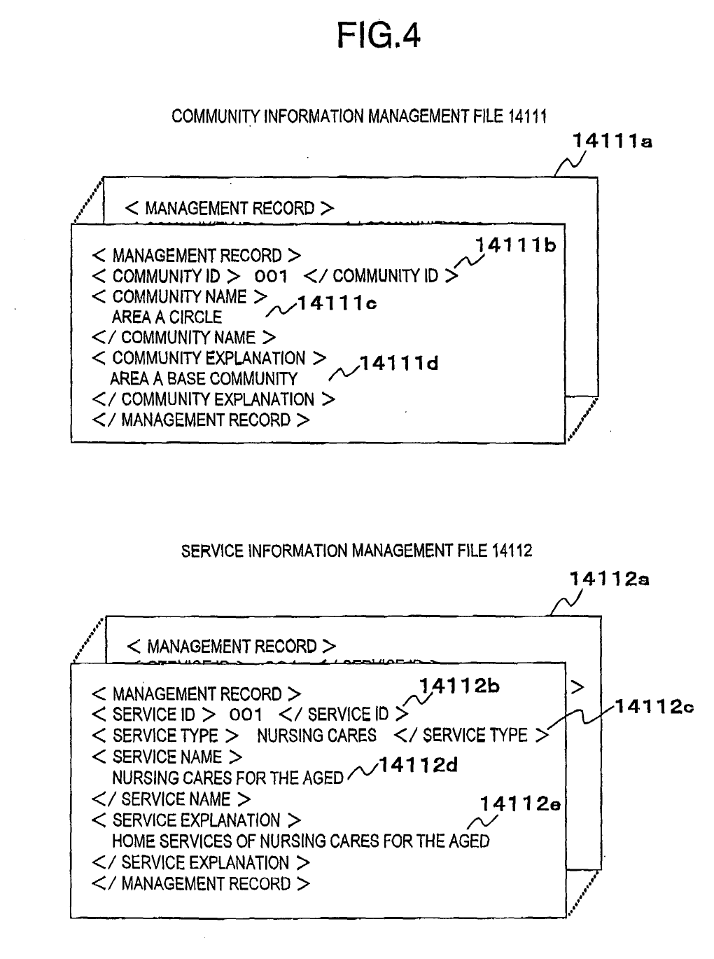

In the community/service management file 1411, there are registered several pieces of information of the individual communities such as the names or explanations of the communities, and the several pieces of the individual volunteer services such as the names, types or explanations of the volunteer services. FIG. 4 shows an example (in the tag type) of the registered contents of the community/service management file 1411. In this example, the management file 1411 is provided with a community information management file 14111 and a service information management file 14112.

As shown in the Figure, each record 14111a to be registered in the community information management file 14111 is provided with: a field 14111b for registering the community ID or the identification information of the community; a field 14111c for registering the community name of the community; and a field 14111d for registering the explanation of the community.

Furthermore, each record 14112a to be registered in the service information management table 14112 is provided with: a field 14112b for registering the service ID or the identification information of the volunteer service; a field 14112c for registering the service type of the volunteer service; a field 14112d for registering the service name of the volunteer service; and a field 14112e for registering the explanation of the volunteer service.

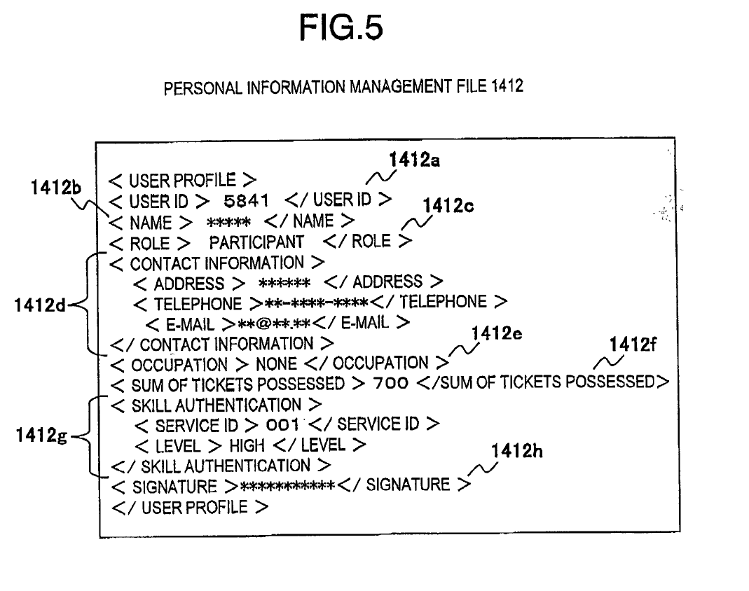

In the personal information management file 1412, there are registered pieces of personal information of the users of the terminals 1 to 4. FIG. 5 is a diagram showing an example of the registered contents of the personal information management file 1412.

As shown in the Figure, the personal information management file 1412 is provided with: a field 1412a for registering the user ID or the identification information of the user; a field 1412b for registering the name of the user; a field 1412c for registering the type (e.g., any of the participant, the activity supporter, the coordinator and the manager) of the user; a field 1412d for registering the contact information (e.g., address, telephone or electronic mail address, etc.) necessary to contact with the user; a field 1412e for registering the occupation of the user; a field 1412f for registering the sum of tickets possessed by the user; a field 1412g for registering the skills (e.g., the service ID and the level) of the user on the target services; and a field 1412h for registering the signature information for the described contents of the personal information management file 1412.

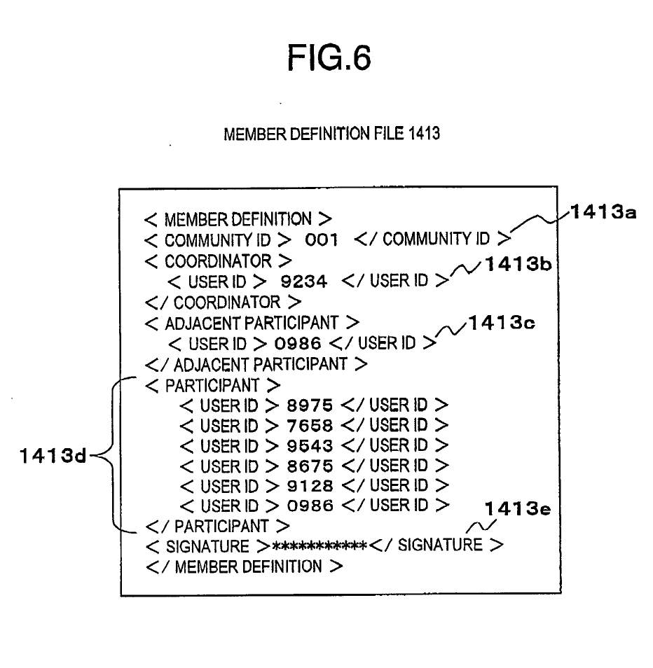

In a member definition file 1413, there are registered pieces of information of the members of the community for the user to participate in or relate to. FIG. 6 is a diagram showing an example (in tag format) of the registered contents of the member definition file 1413.

As shown in the Figure, the member definition file 1413 is provided with: a field 1413a for registering the community ID of the community for the user to participate in or to concern; a field 1413b for registering the user ID of the coordinator concerning the community; a field 1413c for registering the user ID of a next circulated participant (or an adjoining participant) of the information to be circulated in the community; a field 1413d for registering the individual user IDs of the participants to participate in the community; and a field 1413e for registering the signature information on the described contents of the fields 1413a to 1413c of the member definition file 1413.

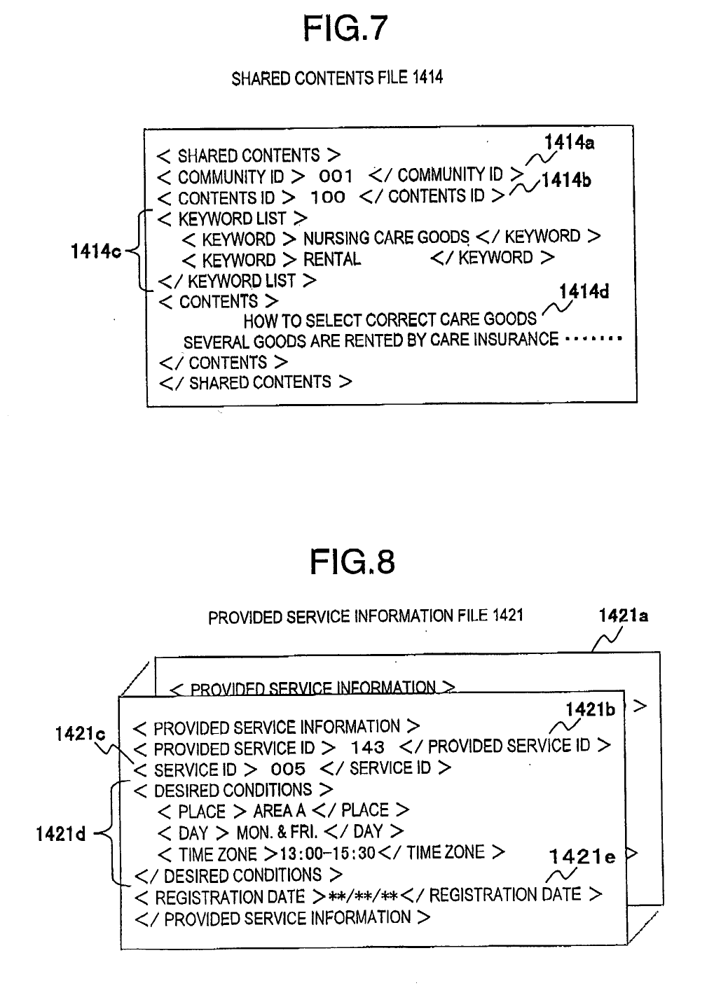

In the shared contents file 1414, there are registered the shared contents which are integrated by the shared contents edition/integration processing module 1517. FIG. 7 shows an example (in tag format) of the registered contents of the shared contents file 1414.

As shown in the Figure, the shared contents file 1414 is provided with: a field 1414a for registering the community ID of a community for the user to participate in or to concern; a field 1414b for registering the contents ID or the identification information of the shared contents; a field 1414c for registering a key word to be used for the shared contents search; and a field 1414d for registering the shared contents themselves.

In the storage unit 14, a participant terminal file unit 142 is an essential for the participant terminal 1. On the other hand, the participant terminal file unit 142 is not essential for the coordinator terminal 2, the supporter terminal 3 and the management terminal 4.

In the participant terminal file unit 142, there is stored provided service information file 1421 which is described in the tag format using the XML, for example. FIG. 8 shows an example of the registered contents (in tag format) of the provided service information file 1421.

As shown in the Figure, each record 1421a registered in the provided service information file 1421 is provided with: a field 1421b for registering the provided service ID or the identification information of the provided service information file; a field 1421c for registering the service ID of the volunteer services provided by the user; a field 1421d for registering the desired conditions (e.g., the desired place, the desired day and the desired time zone, etc.) for the service provision; and a field 1421e for registering the date of registration of the provided service information.

In the storage unit 14, a coordinator terminal file unit 144 is a file group essential for the coordinator terminal 2. On the other hand, the coordinator terminal file unit 144 is not essential for the participant terminal 1, the supporter terminal 3 and the management terminal 4. In the coordinator terminal file unit 144, there are stored a user management file 1441, an application/offer management file 1442, a matching prime plan candidate management file 1443, a matching prime plan management file 1444, a negotiation management file 1445 and an execution result management file 1446. These files are described in the tag format using the XML, for example.

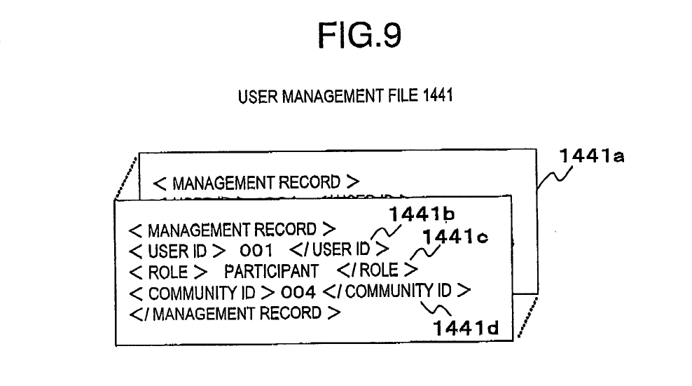

In the user management file 1441, there are registered user IDs of the individual users of the terminals 1 to 4. FIG. 9 shows an example of the registered contents (in tag format) of the user management file 1441.

As shown in the Figure, each record 1441a to be registered in the user management file 1441 is prepared for each user of the terminals 1 to 4 and is provided with: a field 1441b for registering the user ID of the user; a field 1441c for registering the type of the user (e.g., any of the participant, the activity supporter, the coordinator and the manager); and a field 1441d for registering the community ID of the community for the user to participate in or to concern.

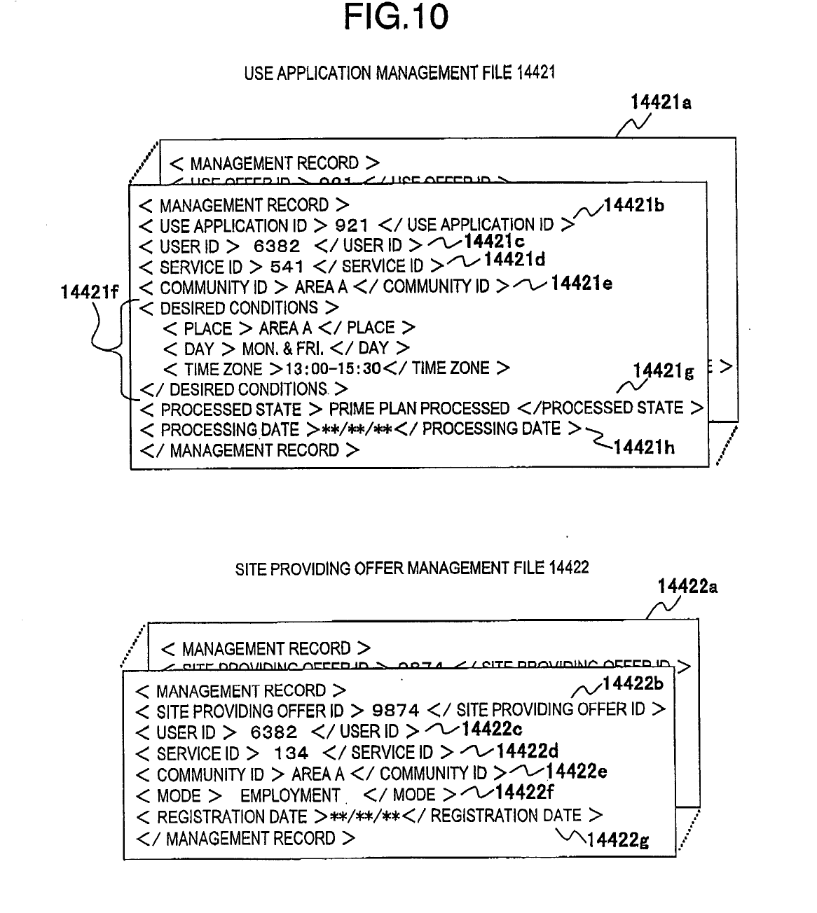

In the application/offer management file 1442, there are registered use application information received from the participant terminal 1, and site providing offer information received from the supporter terminal 3. FIG. 10 shows an example of the registered contents (in tag format) of the application/offer management file 1442. This example is provided with a use application management file 14421 and a site providing offer management file 14422.

As shown in the Figure, each record 14421a to be registered in the use application management file 14421 is provided with: a field 14421b for registering the use application ID or the identification information of the use application record; a field 14421c for registering the user ID of a user; a field 14421d for registering the service ID of the volunteer service which is desired to be enjoyed by the user; a field 14421e for registering the community ID of the community desiring to enjoy the volunteer services; a field 14421f for registering the desired conditions (e.g., the desired place, the desired day and the desired time zone) at the time of enjoying the volunteer services; afield 14421g for registering the processing state (or a state of the matching prime plan creation) of the coordinator for the record; and a field 14421h for registering the processing date of the use application.

Furthermore, each record 14422a to be registered in the site providing offer management file 14422 is provided with: a field 14422b for registering the site providing offer ID or the identification information of the site providing offer record; a field 14422c for registering the user ID of the user; a field 14422d for registering the service ID of the target service for which the site of the business activity or a different activity is provided; a field 14422e for registering the community ID of the target community for which the site is provided; a field 14422f for registering the site providing mode (e.g., employment, link to the portal site, support for staring self business or invitation for participating in various kinds of committees); and a field 14422g for registering the processing data of the site providing offer.

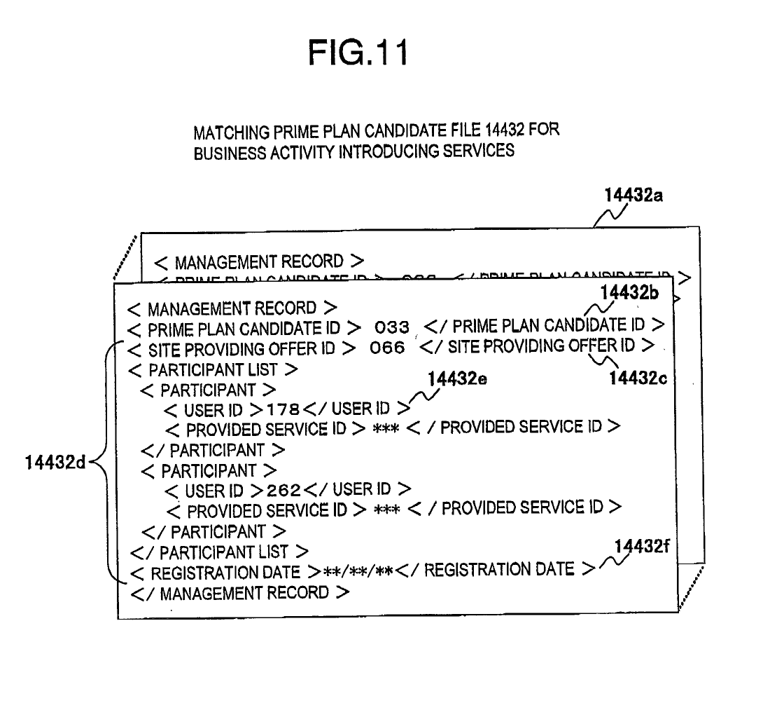

In the matching prime plan candidate management file 1443, there is registered a matching prime plan candidate for supporting the matching prime plan creation by the coordinator. The matching prime plan candidate file 1443 is exemplified by a matching prime plan candidate file 14432 for the business activity introducing services. FIG. 11 shows an example of the registered contents (in tag format) of the matching prime plan candidate file 14432 for the business activity introducing services.

As shown in the Figure, each record 14432a to be registered in the matching prime plan candidate file 14432 for the business activity introducing services is provided with: a field 14432b for registering the prime plan candidate ID or the identification information of the prime plan candidate record; a field 14432c for registering the site providing offer ID; a field 14432d for registering the participant list having described the information (e.g., the user ID and the provided services ID) 14432e of the participant candidate (or the introduced candidate) to be introduced to the site providing offerer; and a field 14432f for registering the date of registration of the prime plan candidate record.

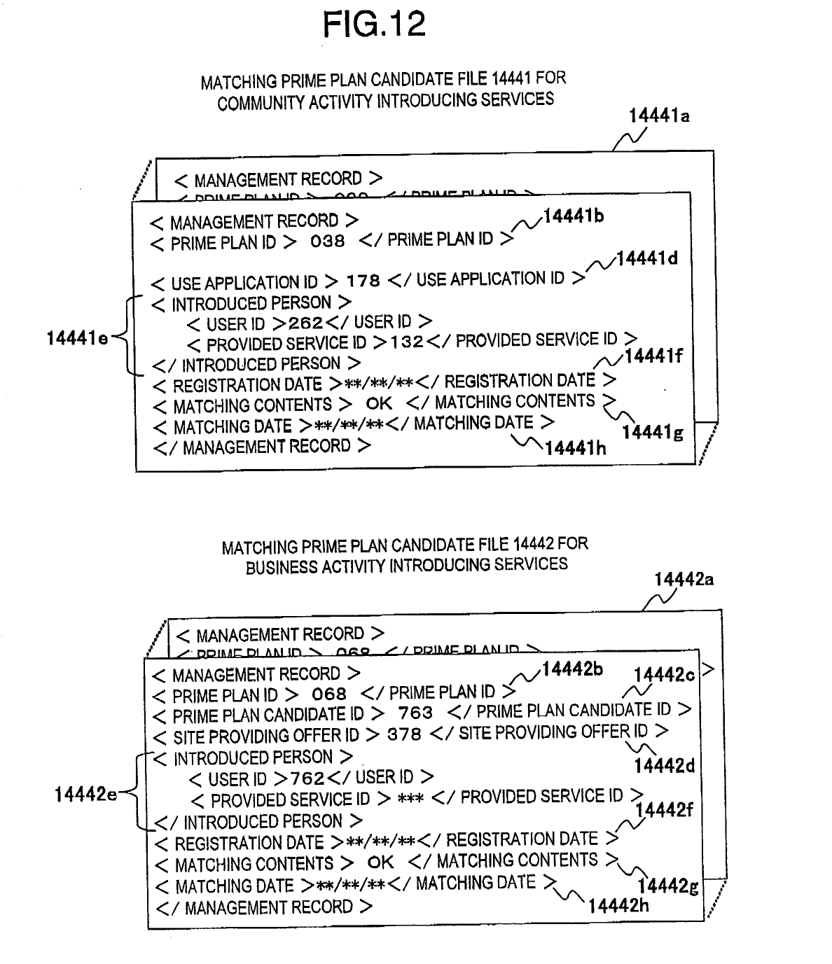

In the matching prime plan management file 1444, there is registered a matching prime plan which has been created by the coordinator. This matching prime plan is exemplified by a matching prime plan file 14441 for the community activity introducing services and a matching prime plan file 14442 for the business activity introducing services. FIG. 12 shows examples of the registered contents (in tag format) of the matching prime plan file 14441 for the community activity introducing services and the matching prime plan file 14442 for the business activity introducing services.

As shown the Figure, each record 14441a to be registered in the matching prime plan file 14441 for the community activity introducing services is provided with: a field 14441b for registering the prime plan ID or the identification information of the prime plan record; a field 14441d for registering the use application ID; a field 14441e for registering the information (e.g., the user ID and the provided service ID) of the introduced person for the use applicant; a field 14441f for registering the registration date of the prime plan record; a field 14441g for registering the matching contents indicating whether or not the use applicant has accepted the matching prime plan; and a field 14441h for registering the registration date of the matching contents.

Furthermore, each record 14442a to be registered in the matching prime plan file 14442 for the business activity introducing services is provided with: a field 14442b for registering a prime plan ID or the identification information of the prime plan record; a field 14442c for registering the prime plan candidate ID of the matching prime plan candidate providing a basis for the matching prime plan creation, a field 14442d for registering the site providing offer ID; a field 14442e for registering the information (e.g., the user ID and the provided service ID) of the introduced person for the site providing offerer; a field 14442f for registering the registration date of the prime plan record; a field 14442g for registering the matching contents indicating whether or not the matching prime plan has been accepted by the site providing offerer; and a field 14442h for registering the registration date of the matching contents.

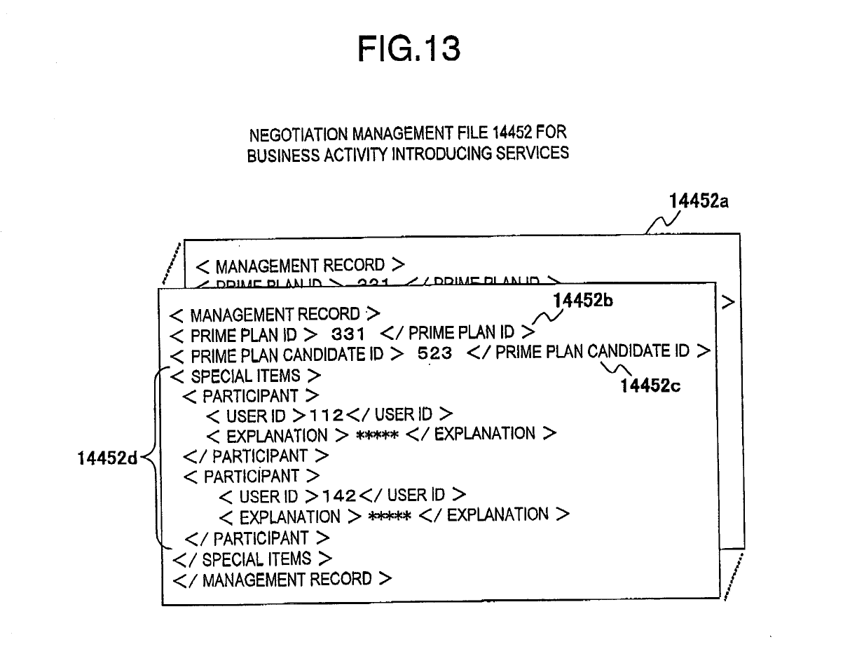

When the coordinator creates the matching prime plan from the prime plan creating screen displayed at the coordinator terminal 2, there is registered in the negotiation management file 1445 the negotiation contents or the like, if necessary, with each of the candidates to-be-introduced who are displayed in the introduced candidate list in the prime plan creating screen. FIG. 13 shows an example of the registered contents (in tag format) of the negotiation management file 1445. In this example, there is provided a negotiation management table 14452 for the business activity introducing services.

As shown in the Figure, each record 14452a to be registered in the negotiation management file 14452 for the business activity introducing services is provided with: a field 14452b for registering the prime plan ID of the matching prime plan; a field 14452c for registering the prime plan candidate ID of the matching prime plan candidate providing a basis for the matching prime plan creation; and a field 14452d for registering the special items (containing the explanation such as the points found at the negotiation, together with the user ID) in the negotiations, which the coordinator has done with the individual candidates to-be-introduced at the time of creating the matching prime plan by using the prime plan creating screen based on the matching prime plan candidate.

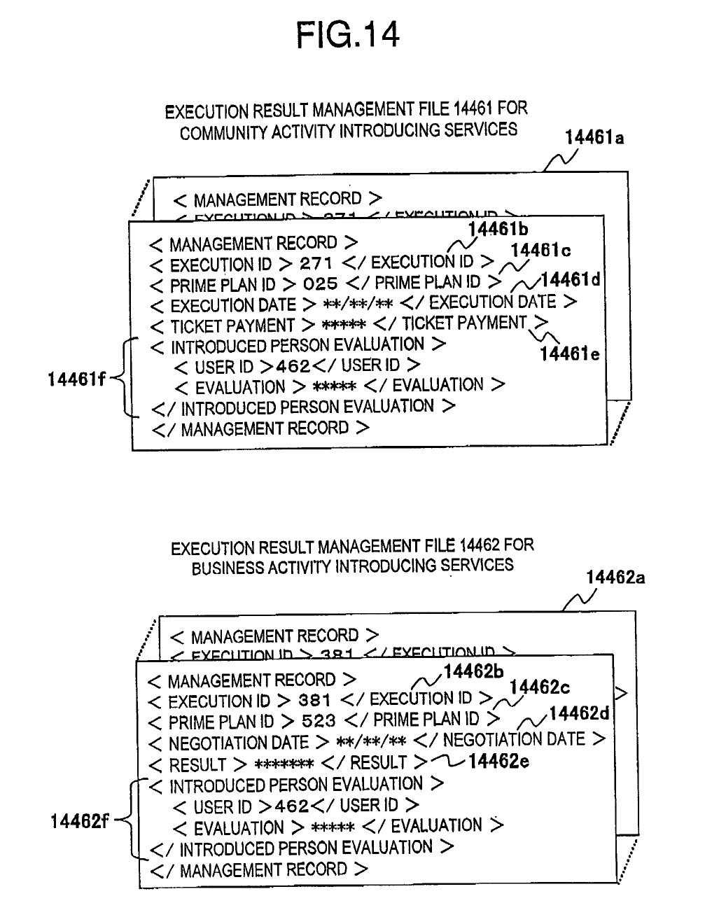

In the execution result management file 1446, there are registered the execution result of the services, which the use applicant has enjoyed from the participant presented in the matching prime plan, and the execution (or negotiation) result on the provision of the site of the business activity or a different activity, which the site providing offerer has done with the participant presented in the matching prime plan. FIG. 14 shows an example of the registered contents (in tag format) of the execution result management file 1446. In this example, there are an execution result management table 14461 for the community activity introducing services and an execution result management table 14462 for the business activity introducing services.

As shown in the Figure, each record 14461a to be registered in the execution result management file 14461 for the community activity introducing services is provided with: a field 14461b for registering the execution ID or the identification information of the record; a field 14461c for registering the prime plan ID of the matching prime plan; a field 14461d for registering the execution date or the date, on which the use applicant enjoyed the services from the participant presented by the matching prime plan; a field 14461e for registering the ticket payment or the sum of the tickets paid to the participant by the use applicant; and a field 14461f for registering the evaluation (e.g., the user ID and the evaluation) on the participant.

Furthermore, each record 14462a to be registered in the execution result management file 14462 for the business activity introducing services is provided with: a field 14462b for registering the execution ID or the identification information of the record; a field 14462c for registering the prime plan ID of the matching prime plan; a field 14462d for registering the negotiation date or the date on which the site providing offerer negotiated with the participant presented in the matching prime plan, a field 14462e for registering the negotiation result (i.e., a final decision on whether a site for the business activity or a different activity is given or not) with the participant; and a field 14462f for registering the evaluation (e.g., the user ID and the evaluation) on the participant.

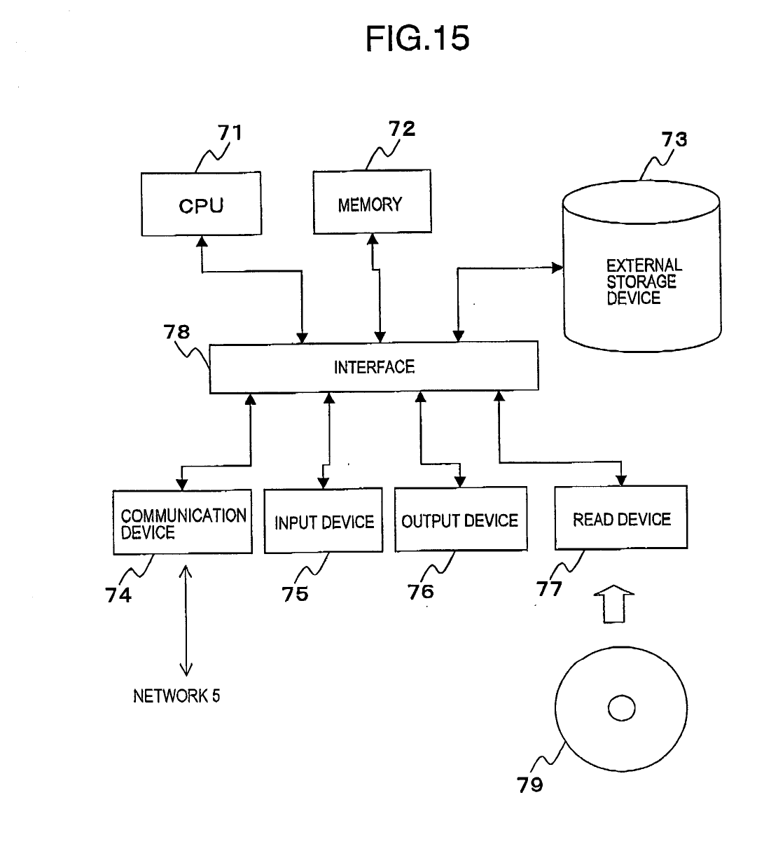

Each of the terminals 1 to 4 having the configuration thus far described can be implemented in such a general computer system when a CPU 71 executes a predetermined program loaded on a memory 72, as is provided with: the CPU 71; the memory 72; an external storage device 73 such as a hard disk; a communication device 74 for communicating with different device through the network 5; an input device 75 such as a keyboard or a mouse, an output device 76 such as a monitor or a printer; a read device 77 for reading data from a storage media 79 such as a CD-ROM or an FD; and an interface 78 for transmitting and receiving data between those individual elements as shown in FIG. 15. The predetermined program may be loaded directly on the memory 72 after it is acquired from the storage media 79 having stored the program through the read device 77 or from the network 5 through the communication device 74, or may be loaded on the memory 72 after it is once stored in the external storage device 73. Here, the external storage device 73 or the like is used as the storage unit 14 as shown in FIG. 3.

Here will be explained actions of a community management center 1 with the above configuration.

The first explanation will be made on the registration processing of the participation in the community activity (S2001 and S2002 of FIG. 2).

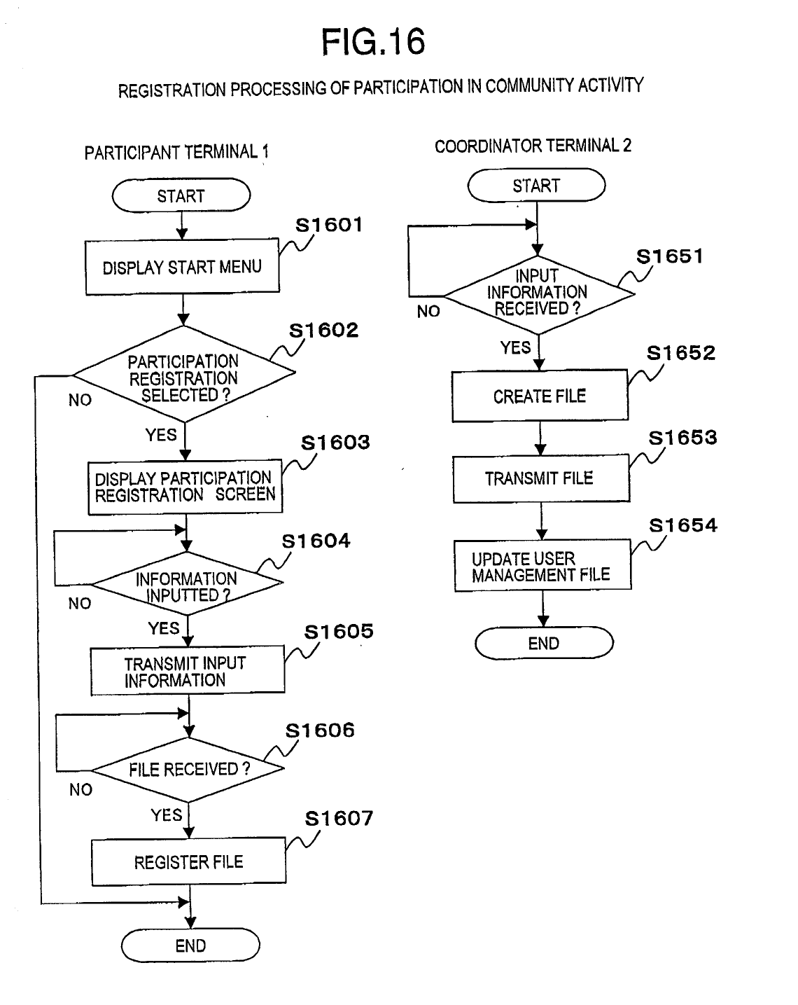

FIG. 16 is a diagram for explaining the registration processing of the participation in the community activity.

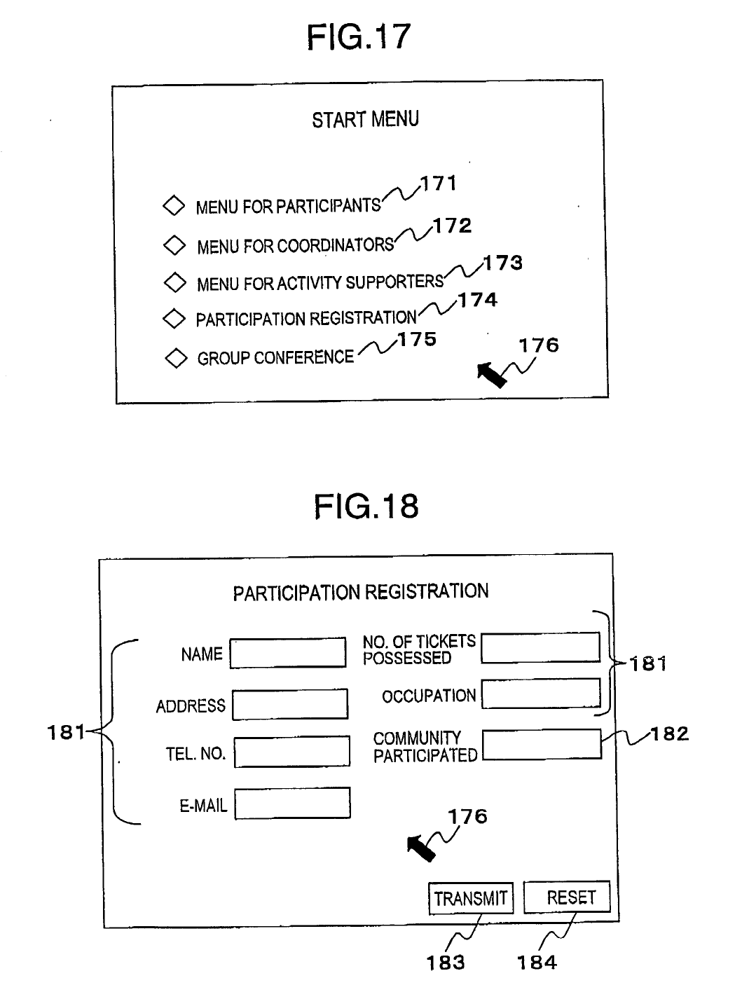

At the participant terminal 1, the application/offer processing module 1515 of the common module unit 151 causes the display unit 13 to display the start menu screen as shown in FIG. 17 (S1601),

Here, the start menu screen shown in FIG. 17 is provided with: an item 171 for displaying the menu for the participants; an item 172 for displaying the menu for the coordinators; an item 173 for displaying the menu for the activity supporters; an item 174 for displaying the participation registration screen; and an item 175 for a group conference using the shared contents. The user is enabled to select any item by moving a cursor 176 through the input unit 12.

When the application/offer processing module 1515 detects that the item 174 for displaying the participation registration screen has been selected (S1602), it displays such a participation registration screen in the display unit 13 (S1603) as to accept the inputs of several pieces of information necessary for creating the personal information management file 1412 and the designations of the community desired by the user to participate in, as shown in FIG. 18.

Here, the participation registration screen shown in FIG. 18 is provided with an input section 181 for inputting the name, the contact information, the occupation information and the sum of tickets possessed, which are described in the personal information management file 1412. Moreover, the screen is provided with an input section 182, in which the communities registered in the community information management file 14111 are displayed in a list so that the user may select a community desired to participate in from a pop-up menu, for example. When the user inputs suitable information to the input sections 181 and 182 through the input unit 12 (S1604) and selects a transmit button 183, the application/offer processing module 1515 transmits the participation registration request containing the inputted information through the broker 1511 and the communication unit 11 to a destination or the predetermined coordinator terminal 2 having registered the address information in advance (S1605). When a reset button 184 is selected, the pieces of information inputted to the input sections 181 and 182 are cleared.

Then, the application/offer processing module 1515 awaits the personal information management file 14111 and the member definition file 1413 to be transmitted from the coordinator terminal 2 through the communication unit 11 and the broker 1511 (S1606). Then, the personal information management file 14111 and the member definition file 1413 received are registered in the common file unit 141 of the storage unit 14 through the file management processing module 1514 (S1607).

Here, the group management processing module 1512 receives such an inquiry through the broker 1511 and the communication unit 11 from the terminals 1 to 4 connected with the network 5 as to concern whether or not its own community ID is identical to the community ID of the terminals 1 to 4 which transmitted the inquiry. If this answer is YES, the processing module 1512 transmits to the terminals 1 to 4 the user ID which is registered in the field 1412a of its own personal information management file 1412. Moreover, the group management processing module 1512 periodically inquires the individual terminals 1 to 4 connected with the network 5, through the broker 1511 and the communication unit 11 whether or not the community ID registered in the field 1413a of the member definition file 1413 is identical to its own community ID. From the terminals 1 to 4, having identical community ID, the user IDs registered in the field 1412a of the personal information management file 1412 are acquired and are registered in the field 1413d of the member definition file 1413 of own terminal 1. Thus, the member definition file 1413 is updated by exchanging the user IDS among the terminals 1 to 4 to participate in or to concern a same community.

On the other hand, at the coordinator terminal 2, the application/offer processing module 1521 of the coordinator terminal module unit 152 receives the participation registration request from the participant terminal 1 through the communication unit 11 and the broker 1511 (S1651). Then, the processing module 1521 gets access through the file management processing module 1514 of the common module unit 151 to the user management file 1441 stored in the coordinator terminal file unit 144 of the storage unit 14. Moreover, the user ID, which is not registered in the user management file 1441, is generated to create the personal information management file 1412 (although the skill authentication is not registered yet at this stage) containing that user ID, the name, contact information, occupation and sum of possessed tickets in the participation registration request, and the electronic signature of the coordinator for those pieces of information.

Moreover, there is created the member definition file 1413 which contains: the generated user ID; the community ID contained in the participation registration request; the user ID of the coordinator registered in the record 1441a which has the community ID and the member type of the coordinator in the user management file 1441; the individual user IDs of the community members registered in the record 1441a that have the community ID and the member type of the participant in the user management file 1441; the user ID of the adjoining participant selected from the user ID of the community member; and the electronic signature of the coordinator for the community ID, the user ID of the coordinator and the user ID of the adjoining participant in the user management file 1441 (S1652). Here, the user ID of the adjoining participant may be such a user ID of the record 1441a in the user management file 1441, for example, which has the latest registration date, out of the records 1441a which have the community ID and the member type of the participant.

Then, the application/offer processing module 1521 transmits the personal information management file 1412 and the member definition file 1413 to the participant terminal 1 or the transmission source of the participation registration request (S1653).

On the other hand, the application/offer processing module 1521 creates the record 1441a of the user management file 1441, in which the user ID, the community ID contained in the participation registration request and the information indicating that the user type is a participant are registered. Through the file management processing module 1514, moreover, access is made to the user management file 1441 stored in the coordinator terminal file unit 144 of the storage unit 14, and the newly created record 1441a is added to the user management file 1441 (S1654).

When the user management file 1441 is updated by the file management processing module 1514, the group management processing module 1512 reports the updated contents (or the newly added record 1441a) through the broker 1511 and the communication unit 11 to the coordinator terminals 2 connected with the network 5. When the group management processing module 1512 receives the updated contents of the user management file 1441 through the broker 1511 and the communication unit 11 from the coordinator terminal 2 connected with the network S, moreover, the group management processing module 1512 uses the file management processing module 1514 to reflect its updated contents on its own user management file 1441. Thus, the individual coordinator terminals 2 can hold the user management files 1441 of the same contents.

Next, there will be described the registration processing of the provided services (i.e., S2003 of FIG. 2).

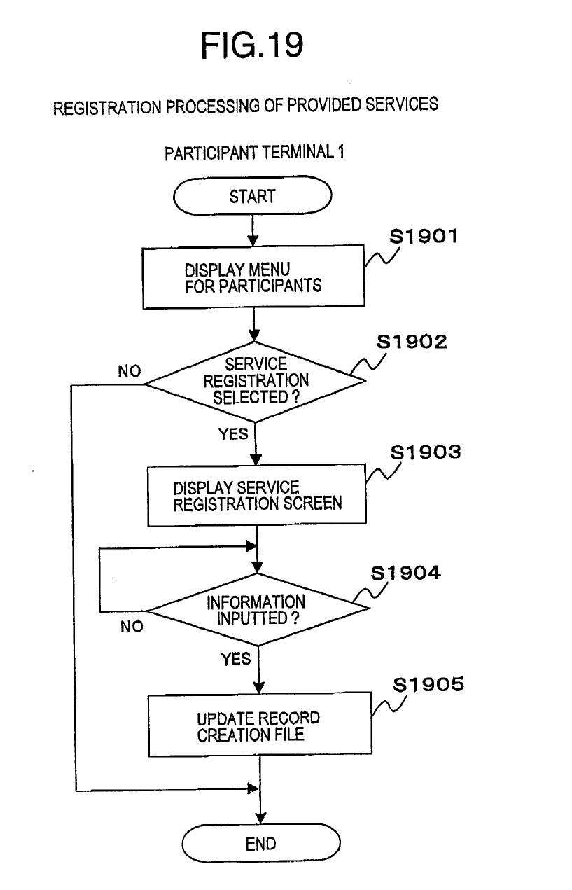

FIG. 19 is a diagram for explaining the registration processing of the provided services.

This flow is started when the item 171 of the participant menu is selected by the user (or participant) at the participant terminal 1 through the start menu screen as shown in FIG. 17.

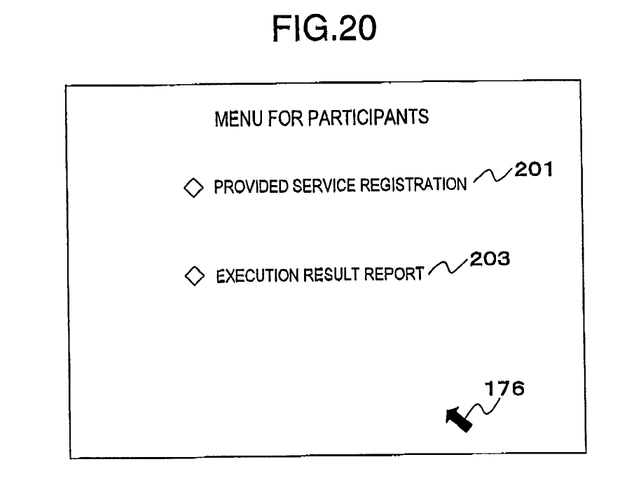

At the participant terminal 1, the application/offer processing module 1515 of the common module unit 151 displays the menu screen for the participants, as shown in FIG. 20, in the display unit 13 (S1901).

Here, the menu screen for the participants shown in FIG. 20 is provided with: an item 201 for registering the provided services; and an item 203 for reporting the reference to the matching prime plan and the execution result of the volunteer services based on the matching prime plan. The user is enabled to select any of the items by using the input unit 12 to move the cursor 176.

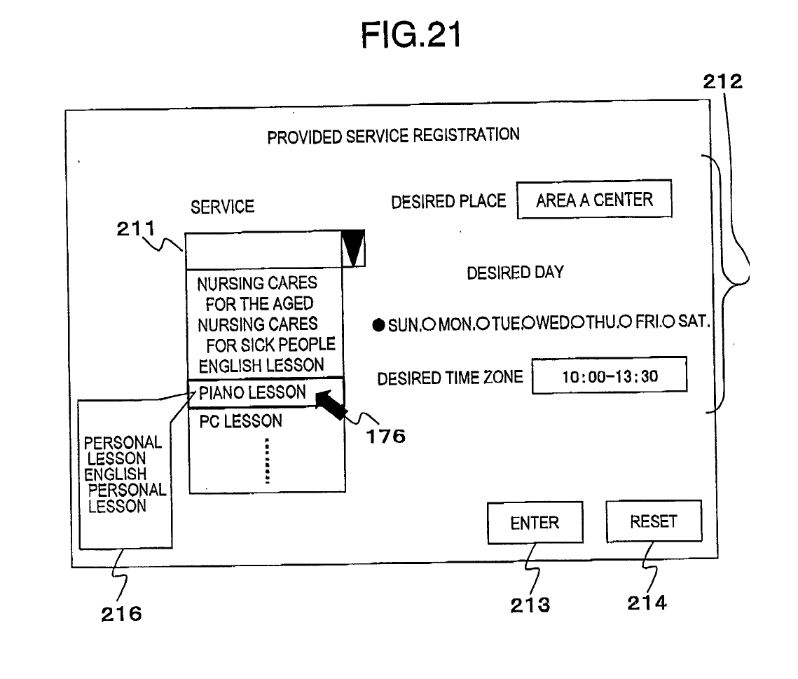

When the item 201 for the provided service registration is selected by the user (S1902), the application/offer processing module 1515 displays such a provided service registration screen in the display unit 13 so as to accept an input of several pieces of information to be registered in the provided service information file 1421, as shown in FIG. 21 (1903).

Here, the provided service registration screen shown in FIG. 21 is provided with an input section 211 for selecting the service names of services having service IDs to be registered in the provided service information file 1421, and an input section 212 for inputting desired conditions for the service offers. The input section 211 is constructed to list up the service names of each record 1412a registered in the service information management file 14112, for example, in the form of a pop-up menu. Moreover, each service name listed up is so linked to the field 14112e of the corresponding record 14112a that a display frame 216 for explaining a desired service is displayed when the cursor 176 is moved to over the name of the desired service. Here, the pieces of information of the input section 211 and 212 are cleared when a reset button 214 is selected.

Now, the user inputs suitable information through the input unit 12 to the input sections 211 and 212 and selects a return button 213 (S1904). Then, the application/offer processing module 1515 creates a unique provided service ID, for example, by connecting a serial number to its own user ID. Moreover, a record 1421a is created which contains: a provided service ID; a service ID of the record 14112a corresponding to the service name selected by the input section 211; desired conditions inputted to the input section 212; and the registration date. Moreover, this record 1421a is added through the file management processing module 1514 to the provided service information file 1421 of the participant terminal file unit 142 (S1905).

Next, here will be described the registration processings (from S2014 to S2015 of FIG. 2) of the execution result report of the community activity introducing services.

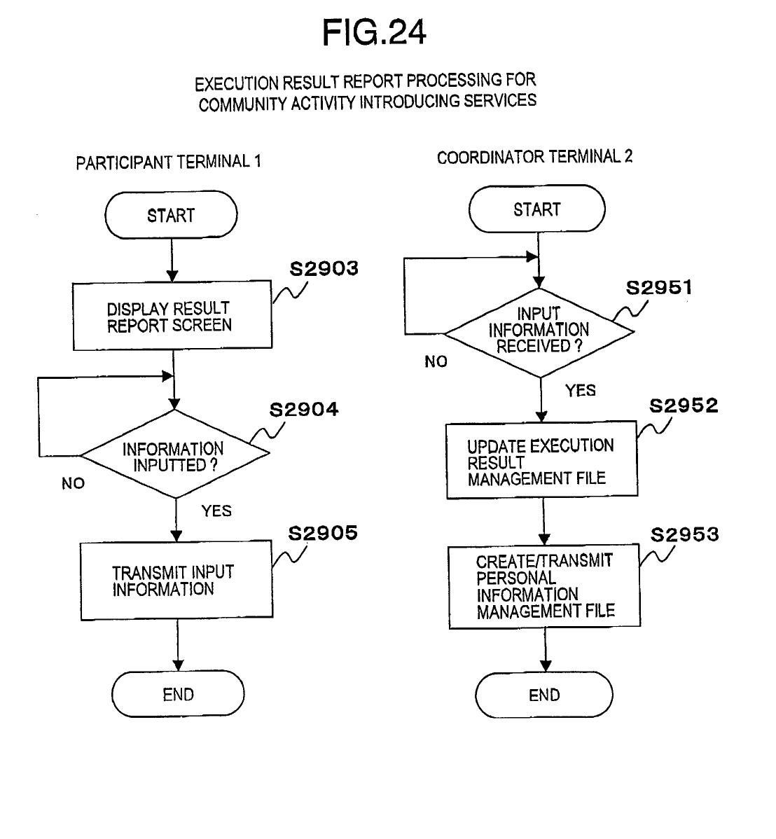

FIG. 24 is a diagram for explaining the registration processings of the execution result reports of the community activity introducing services.

This flow is started when the item 203 of the execution result report is selected by the user of the participant terminal 1 in the menu screen for the participants, as shown in FIG. 20.

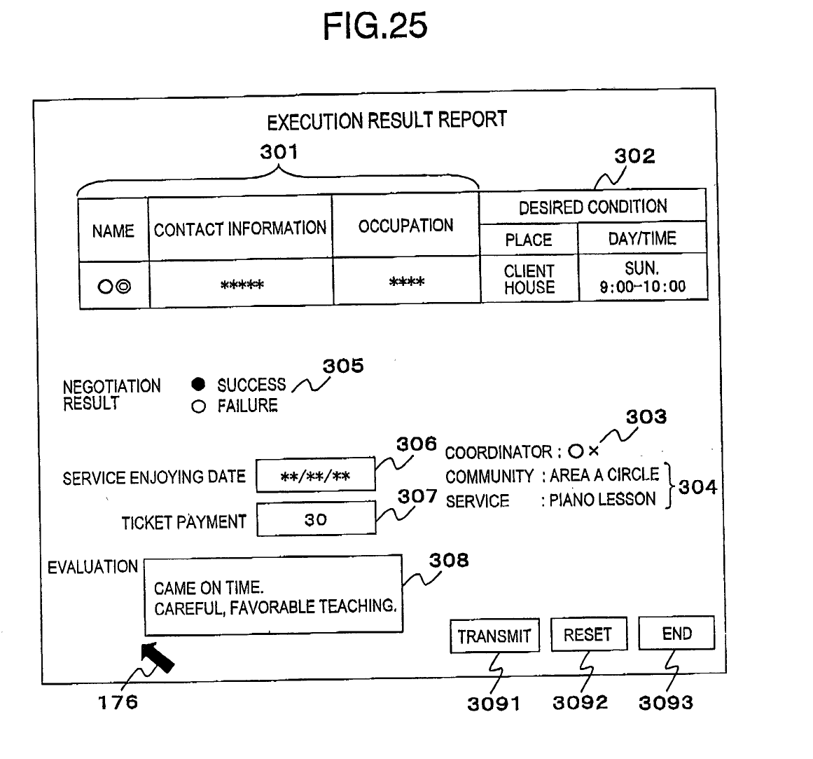

First of all, at the participant terminal 1 of the service user, the application/offer processing module 1515 of the common module unit 151 reports the use application ID of the use application made by the service user for the service offer, to the coordinator terminal 2, and acquires the record 14441a of the matching prime plan, in which the use application ID is registered in the field 14441d. On the basis of the record 1441a acquired, moreover, the execution result report screen, as shown in FIG. 25, is created and displayed in the display unit 13 (S2903).

In the execution result report screen for the community activity introducing services as shown in FIG. 25, reference numeral 301 designates the personal information of the user (or an introduced person) of the participant terminal 1 having the user ID registered in the field 14441e of the record 14441a of the matching prime plan acquired. The application/offer processing module 1515 creates and transmits a personal information inquiry to the participant terminal 1 having the user ID through the communication unit 11 and the broker 1511. In response to the personal information inquiry, the participant terminal 1 transmits the name, contact information and occupation registered in its own personal information management file 1412, to the participant terminal 1 of the inquiry transmission source. At the participant terminal 1 of the inquiry transmission source, therefore, the application/offer processing module 1515 can acquire the personal information of the introduced person indicated in the record 14441a of the matching prime plan acquired.

Further, in the execution result report screen for the community activity introducing services, reference numeral 302 designates a desired condition as to the service provision of the introduced person indicated in the record 14441a of the matching prime plan acquired. The application/offer processing module 1515 creates the provided service inquiry containing the provided service ID registered in the field 14441e of the record 14441a of the matching prime plan acquired, and transmits it through the communication unit 11 and the broker 1511 to the participant terminal 1 having the user ID registered in the field 14441e. In response to the provided service inquiry, the participant terminal 1 extracts the record 1421a having the provided service ID contained in the inquiry, from its own provided service information file 1421, and transmits the desired condition registered in the record 1421a, to the participant terminal 1 of the inquiry transmission source. Accordingly, at the participant terminal 1 of the inquiry transmission source, therefore, the application/offer processing module 1515 can acquire the desired condition on the service provision of the introduced person indicated in the record 14441a of the matching prime plan acquired.

Further, in the execution result report screen for the community activity introducing services, reference numeral 303 designates the name of the coordinator, and reference numeral 304 designates the individual names of the community and the volunteer service, as to which the user (or the use applicant) of the participant terminal 1 desires to enjoy the services. These pieces of information are transmitted together with the record 14441a of the matching prime plan from the coordinator terminal 2.

Moreover, in the execution result report screen for the community activity introducing services: numeral 305 designates a button for selecting the success/failure of the negotiations of the service provision with the introduced person who is specified by the personal information 301 and the desired condition 302; numeral 306 designates an input section for inputting the date/time, at which the services were enjoyed from the introduced person if the negotiations are successful; numeral 307 designates an input section for inputting the ticket sum paid for enjoying the services; and numeral 308 designates an input section for filling the evaluations for the services enjoyed.

By using the matching prime plan/result report screen thus far described, the user (or use applicant) of the participant terminal 1 can negotiate with the service provider introduced by the coordinator, for the service provision. Moreover, the negotiation result button 305 is checked for the negotiation success/failure, and the service enjoying date, the ticket payment and the evaluations for the enjoyed services are inputted to the input sections 306 to 308. When a transmit button 3091 is selected, the result of the negotiations and the pieces of information inputted to the input sections 306 to 308 are fixed. Here if a reset button 3092 is selected, the checked contents of the negotiation result button 305 and the pieces of information inputted to the input sections 306 to 308 are cleared. On the other hand, the processings are ended when the end button 3093 is selected.

When the application/offer processing module 1515 thus receives the information from use applicant (S2904), it creates a result report containing the contents of the information and the prime plan ID contained in the record 14441a of the matching prime plan acquired from the coordinator terminal 2. Then, the processing module 1515 transmits the created result report to the coordinator terminal 2 through the broker 1511 and the communication unit 11 (S2905).

At the coordinator terminal 2, on the other hand, the result registration processing module 1523 of the coordinator terminal module unit 152 receives the result report from the participant terminal 1 through the communication unit 11 and the broker 1511 (S2951). Then, the processing module 1523 registers the contents of the result report in the matching prime plan management file 14441 for the community activity introducing services and the execution result management file 14461 for the community activity introducing services (S2952).

Specifically, the result registration processing module 1523 uses the file management processing module 1514 to get access to the matching prime plan management file 14441 for the community activity introducing services thereby to specify the record 14441a having the prime plan ID contained in the result report, from that file 14441. Moreover, the processing module 1523 registers whether or not the negotiations contained in the result report are successful in the field 14441g of the record 14441a. Moreover, the processing module 1523 registers the date of this day in the field 14441h.

If the answer of the negotiations contained in the result report is “YES”, the result registration processing module 1523 uses the file management processing module 1514 to get access to the execution result management file 14461 for the community activity introducing services of the coordinator terminal file unit 144. Moreover, the new record 14461a is added to the file 14461, and the uniquely created execution ID is registered in the field 14461b of the record 14461a. In the fields 14461c to 14461f, respectively, there are registered the prime plan ID contained in the result report, the date of this day, the ticket payment contained in the result report, the user ID of the introduced person registered in the field 14441e of the record 14441a of the matching prime plan file 14441 for the community activity introducing services having the prime plan ID, and the evaluation of the result report.

Furthermore, if the answer of the negotiations contained in the result report is “YES”, the result registration processing module 1523 updates the personal information management file 1412 of the use applicant and the provider, as indicated in the matching prime plan (S2953) Specifically, the result registration processing module 1523 acquires the user ID of the introduced person (or provider) from the field 14441e of the record 14441a of the matching prime plan file 14441 for the community activity introducing services, the record 14441a having the prime plan ID contained in the result report. Then, the processing module 1523 transmits the personal information inquiry through the communication unit 11 and the broker 1511 to the participant terminal 1 having that user ID. The participant terminal 1 having received the personal information inquiry from the coordinator terminal 2 transmits its own personal information management file 1412 to the coordinator terminal 2. As a result, the coordinator terminal 2 acquires the personal information management file 1412 of the introduced person (or provider). Now, the result registration processing module 1523 adds the ticket payment contained in the result report, to the sum of possessed tickets registered in the field 1412f of the personal information management file 1412 of the introduced person. Then, an electronic signature is newly created for the personal information management file 1412 having the updated number of possessed tickets, and the registered contents of the field 1412h is updated to the new electronic signature. Then, this personal information management file 1412 is transmitted through the broker 1511 and the communication unit 11 to the participant terminal 1 having the user ID of the introduced person. In response to this, the participant terminal 1 having the user ID of the introduced person updates the personal information management file 1412 to the file newly received from the coordinator terminal 2.

Further, the result registration processing module 1523 acquires the use application ID from the field 14441d of the record 14441a of the matching prime plan file 14441 for the community activity introducing services, which has the prime plan ID contained in the result report. The processing module 1523 further acquires the user ID of the use applicant from the field 14421c of the record 14421a of the user application management file 14421 having that user application ID. Then, the processing module 1523 transmits the personal information inquiry through the communication unit 11 and the broker 1511 to the participant terminal 1 having that user ID. In response to the personal information inquiry from the coordinator terminal 2, the participant terminal 1 transmits its own personal information management file 1412 to the coordinator terminal 2. As a result, the coordinator terminal 2 acquires the personal information management file 1412 of the use applicant. Now, the result registration processing module 1523 subtracts the ticket payment contained in the result report, from the sum of possessed tickets registered in the field 1412f of the personal information management file 1412 of the use applicant. Then, the processing module 1523 creates an electronic signature newly for the personal information management file 1412 having the updated ticket payment, and updates the registered contents of the field 1412h to that new electronic signature. Then, the processing module 1523 transmits the personal information management file 1412 through the broker 1511 and the communication unit 11 to the participant terminal 1 having the user ID of the use applicant. In response to this, the participant terminal 1 having the user ID of the use applicant updates the personal information management file 1412 to the file which has been newly received from the coordinator terminal 2.

Here will be described the skill registration processings (from S2016 to S2017 of FIG. 2) of the provider.

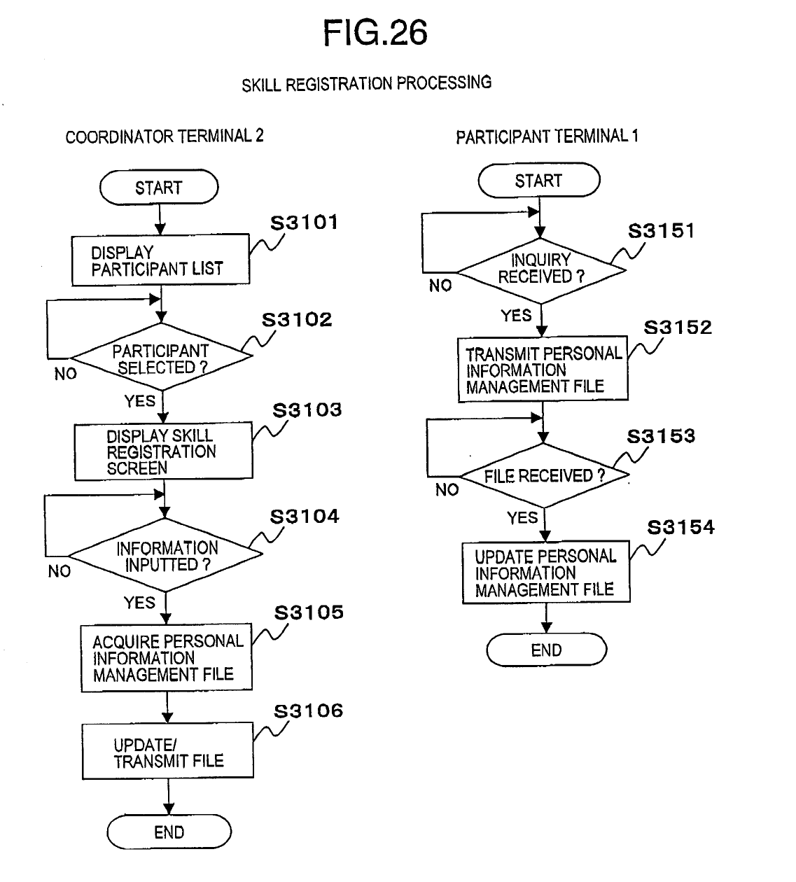

FIG. 26 is a diagram for explaining the skill registration processings.

This flow is started when a skill evaluation item 263 is selected by a user (or a coordinator) in the menu screen for the community activity introducing services, as shown in FIG. 23 and displayed in the display unit of the coordinator terminal 2.

First of all, at the coordinator terminal 2, the result registration processing module 1523 of the coordinator terminal module unit 152 gets access through the file management processing module 1514 to the member definition file 1413 of the common file unit 141, to create a list of the user IDs registered in the field 1413d of the file 1413 (i.e., the user IDs of the participants of the community taken under the charge of the coordinator). Then, the processing module 1523 displays the selection screen for allowing a selection of the participant to be evaluated on the skills, from that list on the display unit 13 (S3101).

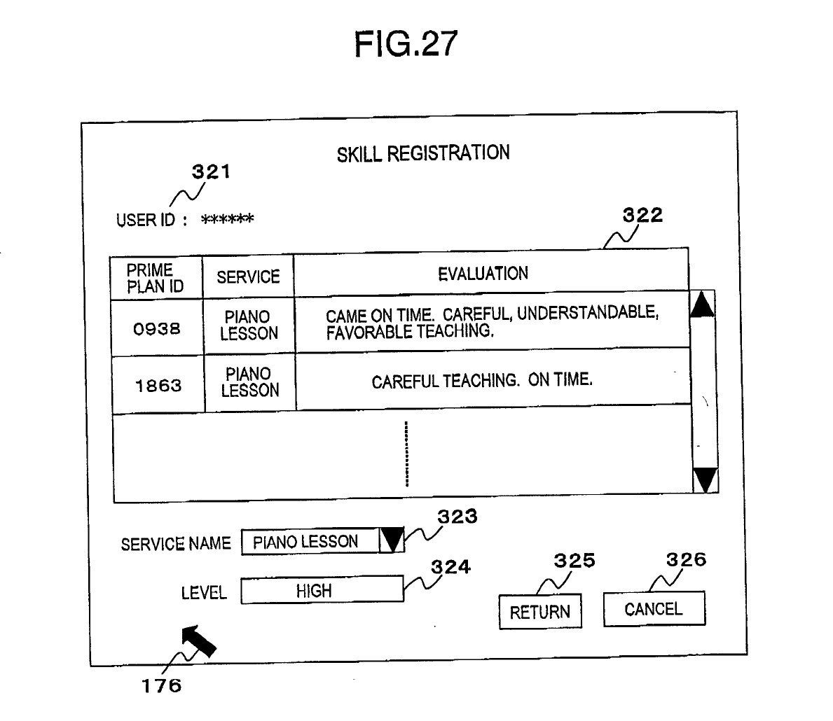

If a participant to be evaluated on the skills is selected by the coordinator through the input unit 12 (S3102), the result registration processing module 1523 gets access to the execution result management file 14461 for the community activity introducing services of the coordinator terminal file unit 144 through the file management processing module 1514, and extracts the record 14461a, in which the user ID of the selected participant is registered in the field 14461f. On the basis of the evaluations registered in the individual fields 14461f of the extracted record 14461a, the skill registration screen for registering the skill evaluations of that selected participant, as shown in FIG. 27, is displayed in the display unit 13 (S3103).

In the skill registration screen shown in FIG. 27, reference numeral 321 designates the user ID of the selected participant. Numeral 322 designates a display frame in which the evaluations of the participant as a provider are listed up. The prime plan IDs and the evaluations recorded individually in the extracted record 14461a are described together with the target service names of the matching prime plans having those prime plan IDs. This service name can be specified by using the prime plan ID as the key to extract the corresponding record 14441a from the matching prime plan file 14441 for the community activity introducing services, by using the use application ID registered in that record 14441a as the key to extract the corresponding record 14421a from the use application management file 14421, and by using the service ID registered in the record 14421a as the key to extract the corresponding record 14112a from the service information management file 14112.

In the skill registration screen, reference numeral 323 designates an input section of the service name, the service being evaluated on the skill. The service names in the display frame 322 are listed up, for example, by the pop-up menu. The coordinator can select the desired service name by using the cursor 176. Moreover, numeral 324 designates an input section for inputting the evaluation level of the skills.

Now, the service name and the evaluation level are inputted to the input sections 323 and 324, and a confirm button 325 is selected (S3104). Then, the result registration processing module 1523 transmits the personal information inquiry to the participant terminal 1 having the user ID of the selected participant, to acquire the personal information management file 1412 from that participant terminal 1 (S3105).

Next, the result registration processing module 1523 registers the service ID and the evaluation level, corresponding to the service name received from the coordinator through the skill registration screen, in the field 1412g of the file 1412 acquired from the participant terminal 1. Moreover, the processing module 1523 newly creates an electronic signature for the personal information management file 1412 having the updated skill evaluation, and updates the registered contents of the field 1412h to that new electronic signature. Then, the processing module 1523 transmits the personal information management file 1412 through the broker 1511 and the transmission unit 11 to the participant terminal 1 transmitted the personal information management file 1412 (S3106).

At the participant terminal 1, the application/offer processing module 1515 of the common module unit 151 receives the personal information inquiry through the communication unit 11 and the broker 1511 from the coordinator terminal 2 (S3151) Then, the processing module 1515 reads a personal information management file 14412 of the common file unit 141 through the file management processing module 1514. Then, the processing module 1515 transmits that file 14412 through the broker 1511 and the communication unit 11 to the coordinator terminal 2 or the inquiry source (S3152).

Then, the application/offer processing module 1515 receives the updated personal information management file 14412 from the coordinator terminal 2 (S3153). The application/offer processing module 1515 replaces the personal information management file 14412 of the common file unit 141 with the updated file received from the coordinator terminal 2, by using the file management processing module 1514 (S3154).

Here will be described the registration processings (from S2018 to S2019 of FIG. 2) of the site providing offer.

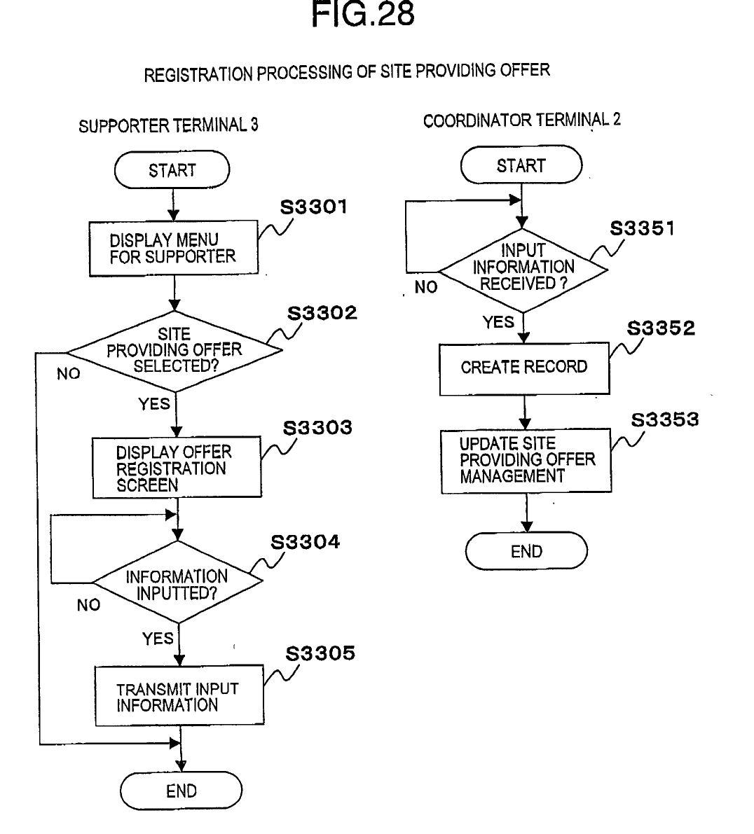

FIG. 28 is a diagram for explaining the registration processings of the site providing offer.

This flow is started when the item 173 of the activity supporter menu is selected by user (or the activity supporter) of the supporter terminal 3 in the start menu screen, as shown in FIG. 17.

First of all, at the supporter terminal 3, the application/offer processing module 1515 displays the menu screen for the activity supporter, as shown in FIG. 29 (S3301).

Here, the menu screen for the activity supporter shown in FIG. 29 is provided with an item 341 for registering a site providing offer, and an item 342 for referring to the matching prime plan and reporting the results of the site providing negotiations for the business activity or a different activity based on the matching prime plan. The user (or the activity supporter) of the supporter terminal 3 is enabled to select any item by moving the cursor 176 using the input unit 12.

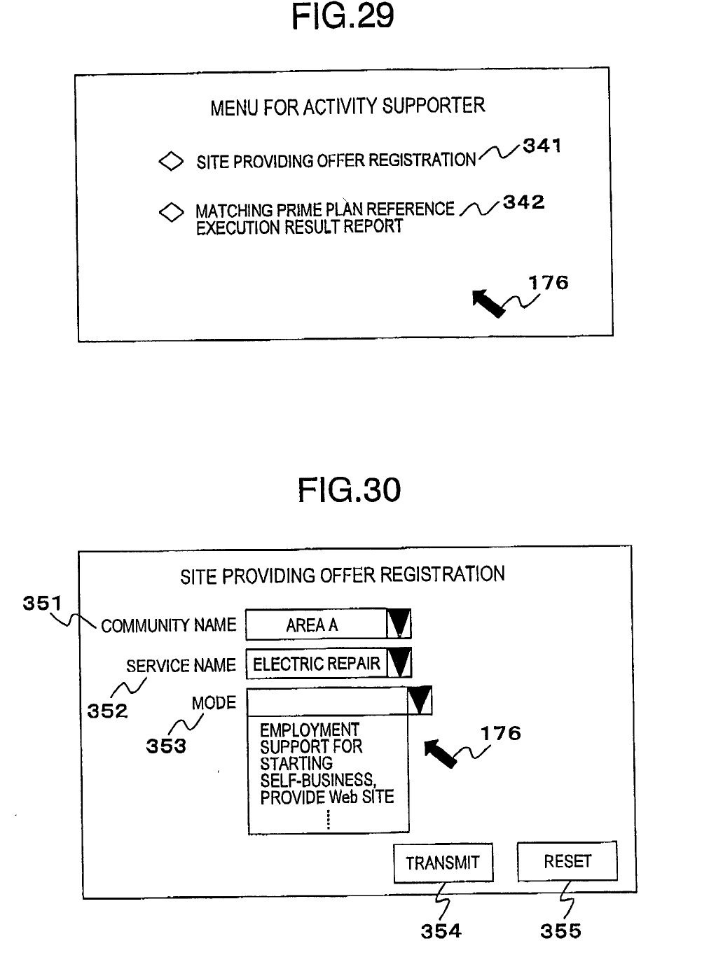

Now, the application/offer processing module 1515 detects that the item 341 for registering the site providing offer is selected (S3302). Then, the processing module 1515 displays the site providing offer registration screen for receiving an input of several pieces of information on the site providing offer, in the display unit 13, as shown in FIG. 30 (S3303).

Here, the site providing offer registration screen shown in FIG. 30 is provided with input sections 351 to 353 for inputting a community name relating to the site of the business activity or a different activity to be provided, a service name and a site providing mode. These input sections 351 to 353 are of the pull-down menu type. When a reset button 355 is selected, the pieces of information inputted to the input sections 351 to 353 are cleared.

Now, the user (or activity supporter) of the supporter terminal 3 inputs a suitable piece of information to those input sections 351 to 353 by using the input unit 12, and selects a transmit button 354 (S3304). Then, the application/offer processing module 1515 gets access through the file management processing module 1514 to the community/service management file 1411 of the common file unit 141, to acquire a community ID corresponding to the community name inputted to the input section 351.

Next, the application/offer processing module 1515 creates an inquiry for the charge of the coordinator containing the acquired community ID, and broadcasts the inquiry to the individual coordinator terminals 2 through the broker 1511 and the communication unit 11. In response to that inquiry, the coordinator terminal 2, in which the community ID registered in its own member definition file 1413 is identical to the community ID contained in the charge inquiry received from the supporter terminal 3, reports its own user ID to that supporter terminal 3. As a result, the supporter terminal 3 acquires the user ID of the coordinator terminal 2 to register the site providing offer.

Here at the supporter terminal 3, the application/offer processing module 1515 acquires the user ID of the coordinator terminal 2 to register the site providing offer. Then, the processing module 1515 creates a site providing offer registration request containing the information inputted from the activity supporter through the site providing offer registration screen and its own user ID acquired from the personal information management file 1412, and transmits the registration request through the broker 1511 and the communication unit 11 to the coordinator terminal 2 having the user ID thus acquired (S3305).

At the coordinator terminal 2, the application/offer processing module 1521 of the coordinator terminal module unit 152 receives the site providing offer registration request from the supporter terminal 3 through the communication unit 11 and the broker 1511 (S3351). Then, the processing module 1521 gets access through the file management processing module 1514 to the site providing offer management file 14422 stored in the coordinator terminal file unit 144. Then, the processing module 1521 generates the site providing offer ID which is not registered in the site providing offer management file 14422, and creates the record 14422a containing the user ID, the service ID, the community ID and the provision mode, which are contained in the site providing offer registration request (S3352). Then, the application/offer processing module 1521 adds this newly created record 14422a to the site providing offer management file 14422 (S3353).

Here will be described the creation support/registration processings (from S2020 to S2025 of FIG. 2) of the matching prime plan for the business activity introducing services.

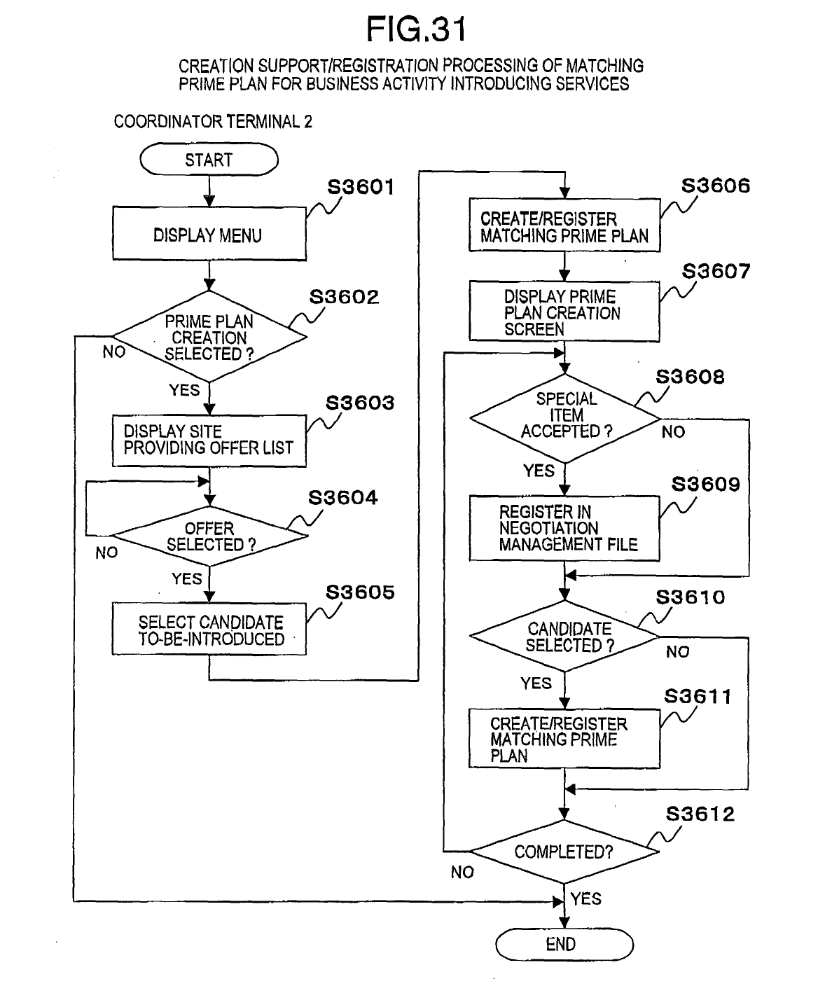

FIG. 31 is a diagram for explaining the creation support/registration processing of the matching prime plan for the business activity introducing services.

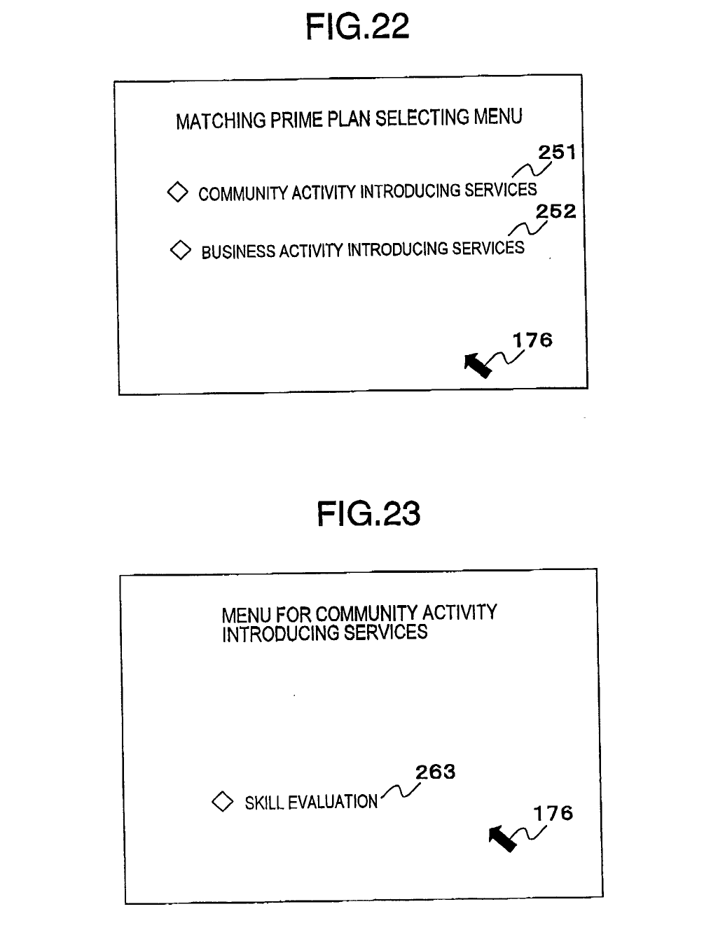

This flow is started when an item 252 for the business activity introducing services is selected by the user (or coordinator) through the select menu, as shown in FIG. 22 and displayed in the display unit 13 of the coordinator terminal 2.

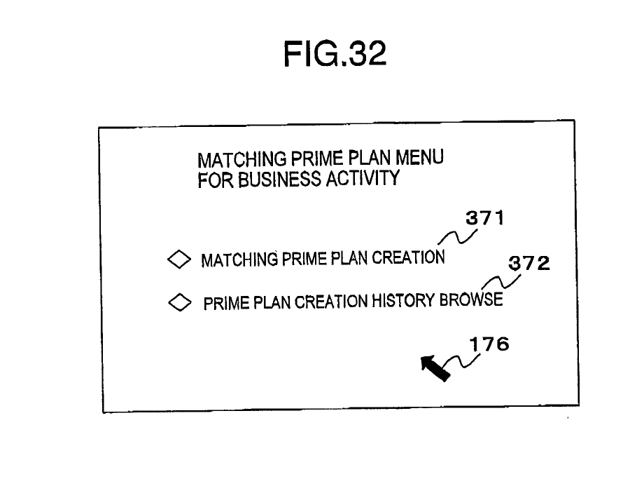

First of all, the prime plan creation/registration processing module 1522 of the coordinator terminal module unit 152 displays the menu screen for the matching prime plan creation/registration processing for the business activity introducing services, in the display unit 13, as shown in FIG. 32 (S3601).

Here, the menu screen shown in FIG. 32 is provided with an item 371 for creating the matching prime plan for the business activity introducing services, and an item 372 for browsing the history of the matching prime plan creation for the business activity introducing services made in the past by the coordinator. The user is enabled to select either item by moving the cursor 176 with the input unit 12.

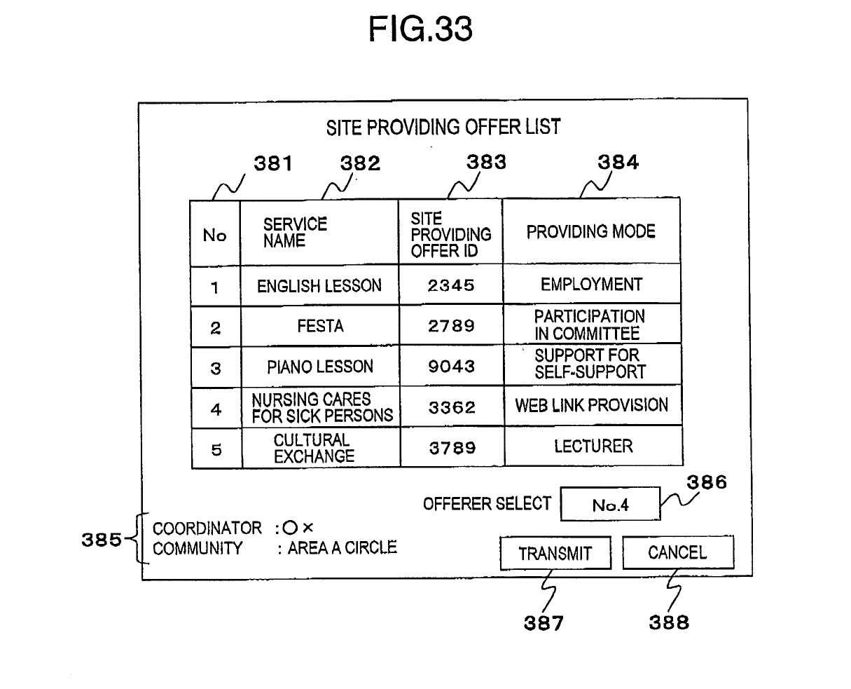

When the matching prime plan creation item 371 is selected (S3602), the prime plan creation/registration processing module 1522 gets access through the file management processing module 1514 of the common module unit 151 to the site providing offer management file 14422 stored in the coordinator terminal file unit 144 of the storage unit 14. Then, the processing module 1522 displays the site providing offer list screen, as shown in FIG. 33, composed of a list of several pieces of information of the site providing offerer, specified by a record 14222a in the site providing offer management file 14422, in the display unit 13 (S3603).

In the site providing offer list screen shown in FIG. 33, reference numeral 382 designates the service name of a service, as to which the site providing offerer can provide a site of the business activity or a different activity. The prime plan creation/registration processing module 1522 uses the file management processing module 1514 to extract the corresponding record 14112a from the service information management file 14112 thereby to specify the service name, by using the service ID registered in the field 14422d of each record 14222a of the site providing offer management file 14422 as the key. Moreover, numerals 383 and 384 designate the site providing offer ID and the site providing mode, which are registered in the fields 14422b and 14422f of each record 14222a of the site providing offer management file 14422.

In the site providing offer list screen, numeral 385 designates the name of a coordinator or user and the name of a community taken under the charge of the coordinator. The prime plan creation/registration processing module 1522 uses the file management processing module 1514 to get access to the personal information management file 1412 and the member definition file 1413, as stored in the common file unit 141, thereby to acquire the name and the community name from those files.

Serial numbers 381 are attached to the several pieces of information of the individual site providing offerers in the site providing offer list screen. When the user uses the input unit 12 to input the desired serial number 381 to an input section 386 and to select a return button 387 (S3604), the prime plan creation/registration processing module 1522 uses the file management processing module 1514 to specify the record 14422a having the site providing offer ID corresponding to the selected serial number 381, from the site providing offer management file 14422 stored in the coordinator terminal file unit 144. Then, the processing module 1522 selects a candidate (or introduced candidate) of the participant to be introduced to the site providing offerer, the user ID of which is registered in the field 14422c of that record 14422a (S3605).

Specifically, the service ID, as registered in the field 14422d, of the record 14422a having the site providing offer ID corresponding to that selected serial number 381 is specified to create a candidate inquiry (for the business activity) having that service ID. The candidate inquiry is transferred, after given the electronic signature of the coordinator, to the group management processing module 1512. In response to this, the group management processing module 1512 uses the file management processing module 1514 to get access to the member definition file 1413 stored in the common file unit 141, thereby to acquire the user ID of the adjoining participant, to which the candidate inquiry is to be transmitted. Then, the processing module 1512 transmits the candidate inquiry through the broker 1511 and the communication unit 11 to the participant terminal 1 having that user ID.

At the participant terminal 1, the application/offer processing module 1515 of the common module unit 151 receives the candidate inquiry through the communication unit 11 and the broker 1511. At first, the security management processing module 1513 then verifies the electronic signature of the candidate inquiry, on the basis of the public key of the coordinator. If the verification is successful, the security management processing module 1513 gets access to the personal information management file 1412 stored in the common file unit 141 though the file management processing module 1514, thereby to examine whether or not the service ID of the skill authentication registered in the field 1412g is identical to the service ID contained in that candidate inquiry. If this answer is YES, the user ID registered in the personal information management file 1412 is transmitted through the broker 1511 and the communication unit 11 to the coordinator terminal 2 having the user ID of the coordinator registered in the member definition file 1413. Moreover, the candidate inquiry is transmitted through the broker 1511 and the communication unit 11 to the participant terminal 1 having the user ID of the adjoining participant registered in the member definition file 1413. If the service ID of the skill authentication is not identical to the service ID contained in the candidate inquiry, what is processed is only to transmit that candidate inquiry to the participant terminal 1 having the user ID of the adjoining participant registered in the member definition file 1413.

The coordinator terminal 2 acquires, from each of the participant terminals 1 that participate in the community taken under the control of the coordinator, such a user ID of the participant that the service of the skill authentication is identical to the service of the site providing offer selected by the coordinator. At the coordinator terminal 2, the prime plan creation/registration processing module 1522 selects the individual participants specified by those user IDs, as the introduced candidates.

Next, the prime plan creation/registration processing module 1522 uses the file management processing module 1514 to get access to the matching prime plan candidate file 14432 for the business activity introducing services stored in the coordinator terminal file unit 144, thereby to create a unique prime plan candidate ID which is not registered in any record 14432a of that file 14432. Then, the record 14432a containing that prime plan candidate ID, the site providing offer ID of the site providing offer selected, the participant list describing the individual user IDs acquired from the participant terminals 1, and the registration date (or the date of this day) is newly created and is added to the matching prime plan candidate file 14432 for the business activity introducing services (S3606).

Moreover, the prime plan creation/registration processing module 1522 uses the file management processing module 1514 to get access to the negotiation management file 14452 for the business activity introducing services, as stored in the coordinator terminal file unit 144, thereby to add the new record 14452a to that file 14452. Moreover, the created prime plan candidate ID is registered in the field 14452c of that record 14452a.

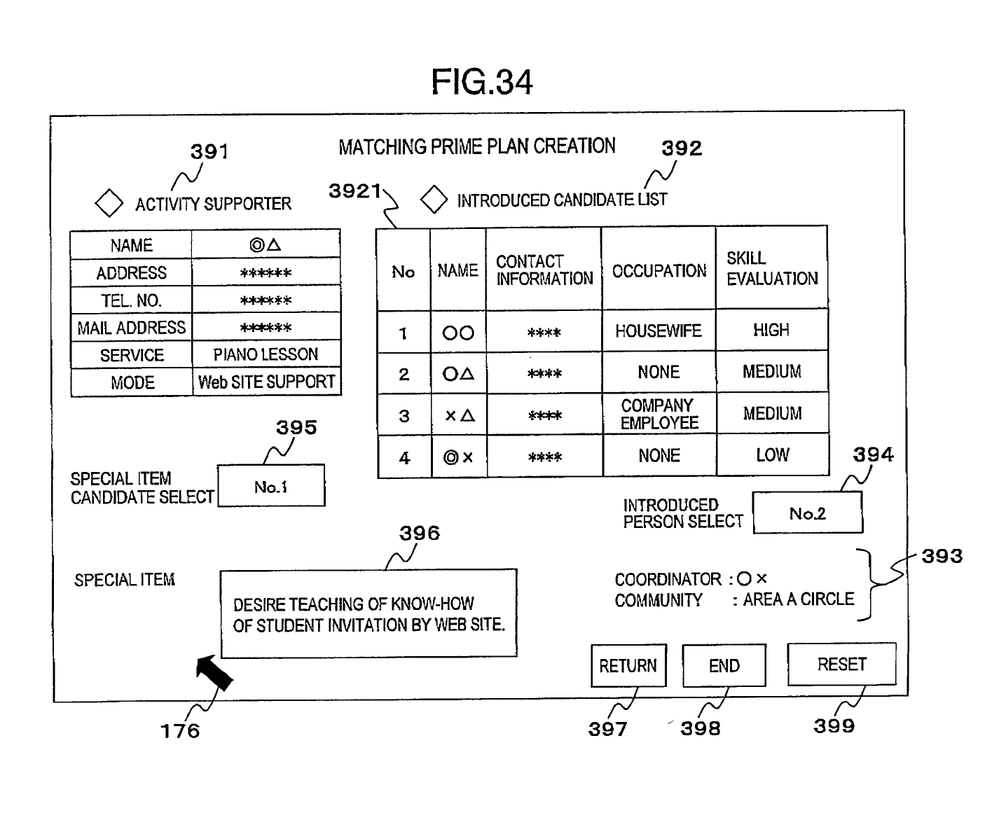

Next, the prime plan creation/registration processing module 1522 uses the file management processing module 1514 to get access to the matching prime plan candidate file 14432 for the business activity introducing services, as stored in the coordinator terminal file unit 144, thereby to specify the record 14432a containing the site providing offer ID of the selected site providing offer. On the basis of this record 14432a, moreover, the prime plan creation screen, as shown in FIG. 34, is displayed in the display unit 13.

In the prime plan creation screen shown in FIG. 34, reference numeral 391 designates the several pieces of information (or site providing offer information) of the site providing offerer which is specified by the site providing offer ID registered in the record 14432a of the matching prime plan candidate file 14432 for the business activity introducing services.

Of the site providing offer information 391, the site providing mode can be acquired, by using the site providing offer ID as the key, from the record 14422a extracted from the site providing offer management file 14422. Moreover, the service name can be acquired, by using the service ID registered in the extracted record 14422a as the key, from the record 14112a extracted from the service information management file 14112. Still moreover, the personal information of the site providing offerer such as the name or the contact information is acquired in the following manner.

Specifically, the prime plan creation/registration processing module 1522 transmits the personal information inquiry through the broker 1511 and the communication unit 11 to the supporter terminal 3 having the user ID registered in the extracted record 14422a. In the supporter terminal 3, the application/offer processing module 1515 of the common module unit 151 receives the personal information inquiry from the coordinator terminal 2 through the communication unit 11 and the broker 1511. Then, the processing module 1515 uses the file management processing module 1514 to get access to the personal information management file 1412 stored in the common file unit 141 of the storage unit 14, thereby to transmit the information of that file 1412 to the coordinator terminal 2. As a result, the prime plan creation/registration processing module 1522 acquires the personal information of the site providing offerer such as the name or the contact information.

In the prime plan creation screen, moreover, numeral 392 designates several pieces of information (or introduced candidate information) containing the skill evaluations of the individual introduced candidates registered in the field 14432d of the record 14432a extracted from the matching prime plan candidate file 14432 for the business activity introducing services. This introduced candidate information 392 is specified, like the site providing offerer information 391, by acquiring the personal information management file 1412 from the participant terminals 1 having the user IDs of the introduced candidates registered in the field 14432d of the record 14432a.

Here, the introduced candidate information 392 is set with a link to the special items for the introduced candidate so that the special items for the candidate are blown off and displayed like the display frame 216 shown in FIG. 21, for example, by moving the cursor 176 to arbitrary introduced candidate information 392. The special items are specified by extracting the explanation of the introduced candidate corresponding to the user ID registered in the field 14432d of the extracted record 14432a, from each record 14452a of the negotiation management file 14452 for the business activity introducing services. In the prime plan creation screen, moreover, numeral 393 designates a name of the coordinator or the user of this coordinator terminal 2 and the name of the community taken under the charge of that coordinator. These pieces of information can be specified from the personal information management file 1412 and the member definition file 1413 stored in the common file unit 141.

To each introduced candidate information 392 in the prime plan creation screen, moreover, there is attached a serial number 3921. When the coordinator or the user of this coordinator terminal 2 uses the input unit 12 to input the desired serial number 3921 to an input section 394 and to select a return button 397, the prime plan creation/registration processing module 1522 receives that serial number 3921 inputted. Moreover, the serial number 3921 of the introduced candidate information 392, to which a special item is to be added, is inputted to an input section 395, and the special item to the introduced candidate is inputted to an input section 396. When the return button 397 is then selected, the prime plan creation/registration processing module 1522 receives the serial number 3921 and the special item inputted.

If the reset button 399 is selected, the pieces of information which have been inputted to the input sections 394 to 396 are cleared. When the end button 398 is selected, on the other hand, the finishing instruction is reported to the prime plan creation/registration processing module 1522.

By using the prime plan creation screen thus far described, the coordinator or the user of the coordinator terminal 2 is enabled to select the participant to be introduced to the activity supporter (or site providing offerer) specified with the site providing offer information 391 in the prime plan creation screen, from the introduced candidates specified with the individual pieces of introduced candidate information 392 in the prime plan creation screen. Moreover, the introduced candidate selected can be inputted to the coordinator terminal 2 by using the input section 394 and the return button 397.

Furthermore, the coordinator is enabled by use of phone or electronic mail to negotiate with the introduced candidates specified by the introduced candidate information 392 in the prime plan creation screen, individually for providing the site of the business activity or a different activity. If there is any request or a point to be noted from the introduced candidate, the explanation as to such request or point to be noted can be inputted to the coordinator terminal 2 by using the input sections 395 and 396 and the confirm button 397.

Now, when the prime plan creation/registration processing module 1522 receives the serial number 3921 or the above explanation inputted to the input sections 395 and 396 through the input unit 12 (S3608), it specifies the user ID of the introduced candidate corresponding to that serial number 3921. Then, the processing module 1522 uses the file management processing module 1514 to get access to the negotiation management file 14452 for the business activity introducing services, as stored in the coordinator terminal file unit 144, thereby to add a record 14452a having the prime plan candidate ID of the record 14432a of the matching prime plan candidate file 14432 for the business activity introducing services, which is the basis for the prime plan creation screen, to that file 14452. Then, the processing module 1522 registers the user ID and the special items of the introduced candidate in the field 14452d of that record 14452a (S3609). At a later-described S3611, the processing module 1522 registers the prime plan ID of the matching prime plan in the field 14452b, while waiting that the record of the matching prime plan is registered in the matching prime plan file 14442 for the business activity introducing services.

When the prime plan creation/registration processing module 1522 receives the serial number 3921 inputted to the input section 394 through the input unit 12 (S3610), it specifies the user ID of the introduced candidate corresponding to that serial number 3921. Then, the processing module 1522 uses the file management processing module 1514 to get access to the matching prime plan file 14422, as stored in the coordinator terminal file unit 144 for the business activity introducing services, thereby to add a record 14442a to that file 14442. Moreover, the processing module 1522 registers, individually in the fields 14442b-14442e of that record, the newly created unique prime plan ID, the prime plan candidate ID of the matching prime plan candidate which is the basis for the prime plan creation screen, the site providing offer ID of the site providing offerer specified with the offer information 391 in the prime plan creation screen, and the user ID of the introduced candidate. At this time, the processing module 1522 registers the registration date (or the date of this day) in the field 14442f but leaves the matching contents of the field 14442g unsettled (S3611).

Moreover, the prime plan creation/registration processing module 1522 ends this flow when it receives the report that the finish button 398 in the prime plan creation screen has been selected, through the input unit 12 from the coordinator terminal 2 (S3612).

Next, here will be described the presentation processing of the matching prime plan for the business activity introducing services and the registration processing of the execution result report (from S2026 to S2029 of FIG. 2).

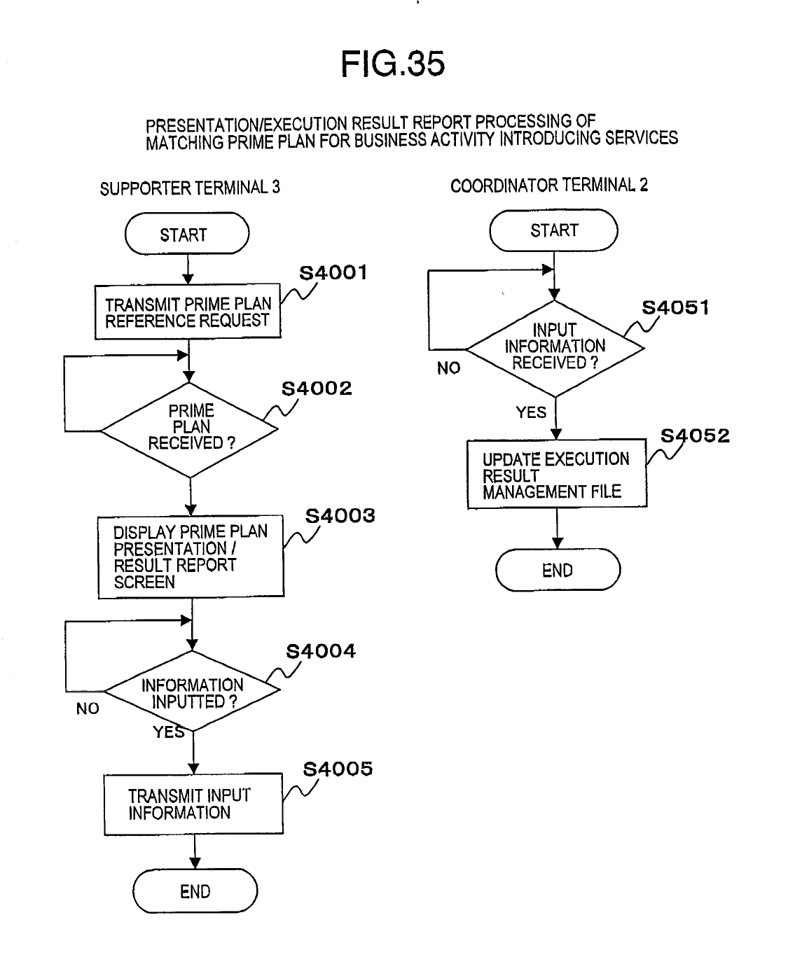

FIG. 35 presents diagrams for explaining the presentation processing of the matching prime plan for the business activity introducing services and the registration processing of the execution result report.

This flow is started when an item 342 for the reference to the matching prime plan and the execution result report is selected in the menu screen for the activity supporter, as shown in FIG. 29, by the user (or activity supporter) of the supporter terminal 3.

First of all, at the supporter terminal 3, the application/offer processing module 1515 of the common module unit 151 creates the matching prime plan reference request (for the business activity) containing its own user ID registered in the personal information management file 1412, and transmits the prime plan reference request through the broker 1511 and the communication unit 11 to the coordinator terminal 2 which offered a site providing by the flow shown in FIG. 28 (S4001). Then, the application/offer processing module 1515 awaits the transmission of the record 14442a of the matching prime plan from the coordinator terminal 2.

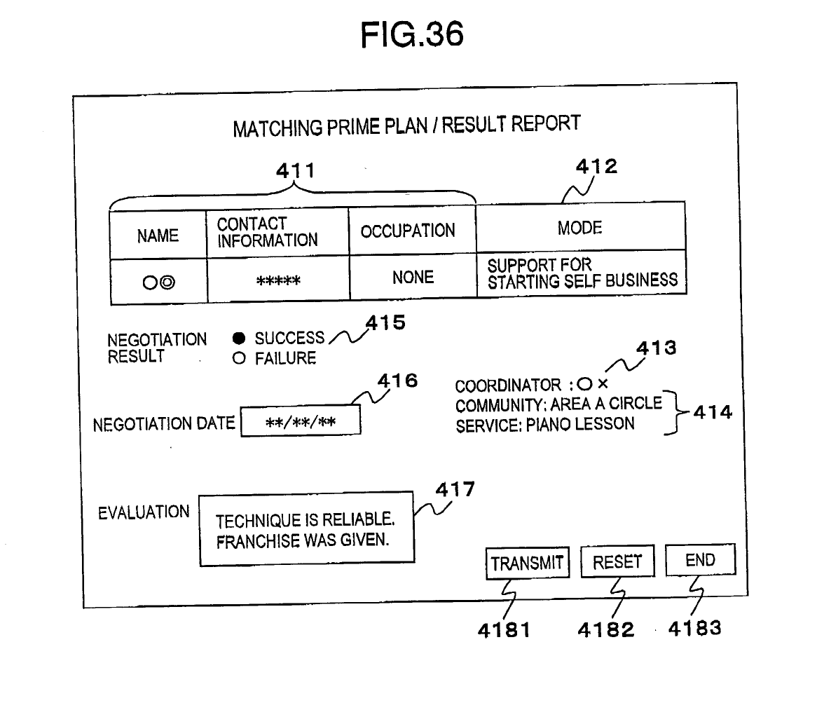

Now, the application/offer processing module 1515 receives the record 14442a of the matching prime plan through the communication unit 11 and the broker 1511 from the coordinator terminal 2 (S4002). On the basis of this record 14442a, the processing module 1515 then creates the matching prime plan/result report screen, as shown in FIG. 36, and displays the screen in the display unit 13 (S4003).

In the matching prime plan/result report screen for the business activity introducing services, as shown in FIG. 36, numeral 411 designates the personal information of the user (or introducer) of the participant terminal 1 having the user ID registered in the field 14442e of the record 14442a of the matching prime plan. The application/offer processing module 1515 creates a personal information inquiry and transmits the inquiry through the communication unit 11 and the broker 1511 to the participant terminal 1 having that user ID. In response to the personal information inquiry, the participant terminal 1 transmits the name, contact information and occupation, as registered in its own personal information management file 1412, to the participant terminal 1 or the inquiry transmission source. In the supporter terminal 3, therefore, the application/offer processing module 1515 can acquire the personal information of the introduced person presented in the matching prime plan.

In the matching prime plan/result report screen for the business activity introducing services, numeral 412 designates a site providing of the business activity or a different activity provided by the user (or activity supporter) of this supporter terminal 3. Moreover, numeral 413 designates a name of the coordinator, and numeral 414 designates the individual names of the community and services, for which the user (or activity supporter) of this supporter terminal 3 provides the site of the business activity or a different activity. These pieces of information are transmitted from the coordinator terminal 2 together with the record 14442a of the matching prime plan.

In the matching prime plan/result report screen for the business activity introducing services: numeral 415 designates a button for selecting a success or failure of the site providing for the introduced person specified by the personal information 411; numeral 416 designates an input section for inputting the date/time of those negotiations; and numeral 417 designates an input section for writing the evaluations of the introduced person.

By using the matching prime plan/result report screen thus far described, the user (or activity supporter) of the supporter terminal 3 is enabled to make negotiations for providing the participant introduced by the coordinator, with the site for the business activity or a different activity. Then, it is checked whether or not the negotiations of the negotiation result button 415 is successful, and the negotiation date and the evaluations of the introduced person are inputted to the input sections 416 and 417. When a transmit button 4181 is then selected, the success/failure of the negotiations is fixed and the pieces of information inputted to the input sections 416 and 417 are also fixed. If a reset button 4182 is selected, the check contents of the negotiation result button 415 and the pieces of information inputted to the input sections 416 and 417 are cleared. When the end button 4183 is selected, the flow is finished.

When the application/offer processing module 1515 receives the information from the activity supporter (S4004), it creates a result report containing the contents of the information and the prime plan ID contained in the record 14442a of the matching prime plan received from the coordinator terminal 2. Then, the processing module 1515 transmits the created result report through the broker 1511 and the communication unit 11 to the coordinator terminal 2 or the transmission source of the record 14442a of the matching prime plan (S4005).

At the coordinator terminal 2, on the other hand, the result registration processing module 1523 of the coordinator terminal module unit 152 receives the result report from the supporter terminal 3 through the communication unit 11 and the broker 1511 (S4051) Then, the processing module 1523 registers the contents of the result report in the matching prime plan management file 14442 for the business activity introducing services and in the execution result management file 14462 for the business activity introducing services (S4052).

Specifically, the result registration processing module 1523 uses the file management processing module 1514 to get access to the matching prime plan management file 14442 for the business activity introducing services, thereby to specify the record 14442a having the prime plan ID contained in the result report, from that file 14442. In the field 14442g of this record 14442a, the success/failure of the negotiations contained in the result report is registered. Further, the date of this day is registered in the field 14442h.

Next, the result registration processing module 1523 uses the file management processing module 1514 to get access to the execution result management file 14462 for the business activity introducing services of the coordinator terminal file unit 144. Then, the processing module 1523 adds the new record 14462a to that file 14462 and registers the uniquely created execution ID in the field 14462b of that record 14462a. In the fields 14462c to 14462f, individually, there are registered the prime plan ID, negotiation date and success/failure of negotiations contained in the result report, the user ID of the introduced person registered in the field 14442e of the record 14442a of the business activity introducing service matching prime plan file 14442 having that prime plan ID, and the evaluations contained in the result report.

There has been described one embodiment of the invention.

In this embodiment, the coordinator is enabled, by using the prime plan creation screen (as referred to FIG. 34) for the business activity introducing services, to select the participant to be introduced to the activity supporter specified by the several pieces of information 391 in that screen, from the individual introduced candidates specified by the several pieces of information 392 in that screen. Here, the several pieces of information 392 of the individual introduced candidates contain the skill evaluations of the introduced candidates. Therefore, the coordinator can judge whether each introduced candidate has a quality of services sufficient for introducing a site of the business activity or a different activity.

Thus in the embodiment, the participant of the community activity can participate in the business activity or a different activity while utilizing the experiences obtained from the community activity. Moreover, the community activity can act as a link to smoothen the human interchanges between the different kinds of activities. It is further possible to support the co-creation which is realized through the volunteer activity such as the Eco Money activity premising the mutual rewards and the coexistence/mutual prosperity of the collaborations which are realized through the business activity such as a regional business.

Here will be described the relations between the Eco Money activity expected to be activated by this embodiment and the regional business activity.

As a trial for combining the Eco Money activity and the regional business, there can be conceived three options. Specifically, 1. An area is activated by the regional business, in which the Eco Money activity is positioned as one means. 2. These two are integrated. 3. The two are made to exist and prosper together. The Eco Money activity is the volunteer activity premised by the mutual rewards, and the regional business is a commercial activity, so that the idea of their integration may cause various problems. According to the embodiment of the invention, it is possible to provide the coexistence and co-prosperity between the Eco Money action of the residents and the regional business, that is, a structure which can exhibit the co-creation to be realized through the mutual reward activity, the coexistence/mutual prosperity of the collaboration to be realized through the commercial activity, and the Synergy effect.

If the services by the residents, for the residents and to the residents are to be provided through the Eco Money activity and the regional business, the services contain following three kinds of specialist actions for supporting the volunteer activity: 1. Support by information technology; 2. Learning and provision of the special knowledge in a volunteer activity; and 3. Commercial activity (or economical activity) for providing the living residents with services or goods. It is necessary to provide a structure, in which those three kinds of special activities are clearly separated but can easily collaborate. Out of these, the activity by the computerized support can be easily separated as the supporting activity using the Web.

In recent years, the regional volunteer activity has spread wider and wider, and its contents are hard to define. Here will be considered examples of application of this embodiment from the viewpoint of aiming at the coexistence/mutual prosperity between the Eco Money activity and the regional business activity (or between the co-creation and the collaboration).

(1) To Support the Self-Reliance and Independence of Seniors Through the Eco Money Activity.

It is necessary to provide such “sites” of information for facilitating mutual stimulations and associations that the business activity of an enterprise for providing works, an Eco Money activity for providing opportunities of learning or labors and for interchanging the demands smoothly, a collaboration activity such as the volunteer activity and a co-creation activity aiming at an improvement in those activities are individually made vigorously by using the system of the embodiment, and that the result of the co-creation activity such as a community learning is easily utilized as the collaboration activity, and that a target discovered as a result of the collaboration activity is quickly reflected on the co-creation activity. Especially at the initial stage of the social activity the person having provided the learning or services as the volunteer activity such as the participation in the Eco Money activity naturally desires to receive the more reasonable evaluation as the ability improves the better. This talented working power is also useful for the regional industry. In this case, there is needed a structure which acknowledges the results of the Eco Money activity or the like to mediate the participation in the regional business activity. The embodiment can be applied to the structure.

(2) To Support the Self-Reliance and Independence Through the Learning of the Special Knowledge on the Support of the Living Residents.

For discriminating the learning and provision of the special knowledge on the support of the living residents by the volunteer activity definitely from the commercial activity to provide the living residents with the goods or services, there is needed a structure which can separate and connect the activity to provide the result of the learning and the systematizing result of the special knowledge on the support of the living residents and the activity to provide a home page for providing services/goods useful for the living residents on the basis of the given knowledge. For example, it is desired to be possible to separate and connect the allowance of a link to the Web portal site (or antenna shop) opened in a region as the regional business activity and the Web site for providing the site of knowledge learning group activity as the Eco Money activity. The embodiment can be applied to that structure.

By using the shared contents search/distribution processing module 1516 and the shared contents edition/integration processing module 1517 in this embodiment, the participants can share pieces of mutual information and can write additional information easily. By using this function, it is possible to provide the site of the knowledge learning group activity.

(3) To Support the Self-Reliance and Independence Through the Culture/Knowledge Creation Activity.

The cultural activity of a region covers many divergences such as Jazz, Japanese drum, Noh songs, dances, tours of historic spots or compilation of cultural history. The activity may be highly made vigorous by preparing, for the participants, the environment for acquiring the values. For example, a local hotel or a regional business may exploit the learning result of the local art learning group for the business activity. The embodiment can be applied to this creation activity.

Here, the aforementioned functions for the participants to share their mutual information and to write the additional information easily can also be used in the case a shop of regional souvenirs is introduced on the web-page of the historic spot or cultural history which has been compiled by the learning group.

(4) To Support the Self-Reliance and Independence Through Festivals.

The Festa or means for the symbiosis between the regional electronic community and the Real Community is an activity, in which the residents act as main members, and gives a clear structure in which a shopping mall may participate for the Eco Money activity. A group of residents offers (or recruits the participants in its plan) as a beneficiary of the ECO Money activity on the basis of the plan of a festival, and the residents who wishes to participate in the execution side of the festival offer as a provider. The embodiment can be applied to the Festa.

Here, the invention should not be limited to the embodiment thus far described but can be modified in various manners within the range of its scope.

For example, the embodiment has been described on the case of the business activity introducing services, in which the participant is introduced to the activity supporter. However, the invention can also be applied to the case in which the shared contents of the community members are introduced to the activity supporter.

First of all, the electronic signature by the coordinator is made for the shared contents by the security management processing module 1513 at the coordinator terminal 2, and its data is registered in the field 1414e of the shared contents file 1414.

Next, a site providing offer is transmitted together with the key word of the contents to be introduced, to the predetermined coordinator terminal 2. At this coordinator terminal 2, the contents inquiry containing the keyword contained in the site providing offer is broadcast to the individual participant terminals 1, for example. Moreover, the coordinator terminal 2 may receive the report of the presence of the shared contents containing the keyword from the participant terminal 1 and may report the presence to the activity supporter.

Here, the security management processing module 1513 of each participant terminal 1 and each coordinator terminal 2 can verify the data of the electronic signature of the field 1414e of the shared contents file 1414.

Thus, the activity supporter can set its own home page a link to the shared contents reported. As a result, it is possible to open a more attractive home page.

Moreover, the foregoing embodiment has been described on the case in which the introducing service supporting system provides a site for connecting the community activity aiming at exchanging the volunteer services, with the business activity or a different regional activity. However, the invention should not be limited to that embodiment. For example, the invention can also be applied to the activation of an enterprise (or to an effective use of talents), it the community is deemed as a personal (or volunteer) research group in the enterprise and if the activity supporter is deemed as an originator for raising a new project in the enterprise.

In the foregoing embodiment, the construction of each file to be stored in the storage unit 14 is assumed to be the XML file which is enabled to express the text format by using the tag. It is, however, of course the construction of each file to be stored in the storage unit 14 should not be limited to the XML file.

In the embodiment, an IC card configured to be mounted on the terminals 1 to 4 may be used as storage unit 14 or a portion thereof. In the embodiment, moreover, the coordinator terminal file unit 144 of each coordinator terminal 2 may be integrally managed by the file server which is disposed separately of the coordinator terminal 2. Moreover, the personal information management files or the member definition files belonging to the individual terminals 1 to 4 may be integrally managed by the file server which is separately disposed. In the embodiment, moreover, the communications between the terminals 1 to 4 should not be limited to the P2P.

According to the invention, as has been described hereinbefore, mediations can be so supported as to activate or smoothen the exchange of services or goods having multiple values and/or accompanied by the mutual rewards. The mediations between the participants and the activity supporters for providing a site opportunity can be so supported that chances for the business activity or a different activity can be provided to the participants having improved the services through such community activity. As a result, it is possible to support the coexistence/the mutual prosperity of the co-creation and the collaboration.

What is claimed is:

1. A volunteer activity business activity supporting method for supporting a volunteer activity and a business activity through a network connected with a plurality of information processing devices, comprising:
an evaluation information storing step at which an information processing device for a coordinator connected with the network stores an evaluation information of a service provision (containing provisions of goods or other contents) by the volunteer activity, in a storage area over said network in relation to the provider information and the service provision desired condition of a service provider; and
a service provision outputting step at which said information processing device for the coordinator responds to a site providing offer of the site of the business activity from an activity supporter, to refer to the service provision desired condition and the evaluation information of the service provision stored in said storage area and to output an information of the service provision satisfying at least a portion of the contents of said site providing offer to the information processing device for the activity supporter.

2. A volunteer activity/business activity supporting method according to claim 1,
wherein said evaluation information of the service provision is either skill information determined according to the quality of said service provision or authentication information for said service provision inputted from said information processing device for the coordinator.

3. An information processing device for a coordinator to support an activity through a network connected with a plurality of information processing devices, comprising:
means for storing a provider information of a service provider of a volunteer activity, a desired condition for a service provision (containing provisions of goods or other contents) presented by said service provider, and an evaluation information of the service provision, in a storage area formed over said network; and
means for responding to the site providing offer of the site of activity from an information processing device for an activity supporter, to refer to said service provision desired condition and said evaluation information of the service provision stored in the storage area formed over said network, thereby to select the service provision satisfying at least a portion of said site providing offer contents and to output said service provision information selected to said information processing device for the activity supporter.

4. An information processing device for a coordinator to support a volunteer activity and a business activity through a network, comprising:
means for storing a provider information of a service provider of a volunteer activity, a skill information of said service provider, and a desired condition for a service provision (containing provisions of goods or other contents) presented by said service provider, in a storage area formed over said network; and
means for responding to a providing offer of a site of activity from an information processing device for an activity supporter, to refer to said service provision desired condition and said skill information stored in the storage area formed over said network, thereby to select the service provision satisfying at least a portion of said site providing offer contents and to transmit said provider information of the service provider selected to said information processing device for the activity supporter.

5. An information processing device according to claim 4, further comprising:
means for registering evaluation information of the services received by a service use applicant of said volunteer activity from said service provider, as said skill information.

6. A program to be executed in an information processing device for a coordinator to support a volunteer activity and a business activity through a network,
wherein said program executes, when read and executed by said information processing device:
a procedure for storing a provider information of a service provider of a volunteer activity, a skill information of said service provider, and a desired condition for a service provision (containing provisions of goods or other contents) presented by said service provider, in a storage area formed over said network; and
a procedure for responding to a providing offer of a site of activity from an information processing device for an activity supporter, to refer to said service provision desired condition and said skill information stored in the storage area formed over said network, thereby to select the service provider satisfying at least a portion of said site providing offer contents and to transmit said provider information of the service provider selected to said information processing device for the activity supporter.

7. A volunteer activity business activity supporting method for supporting a volunteer activity and a business activity through a network connected with various information processing devices, comprising:
an evaluation information storing step at which an information processing device for a coordinator connected with the network stores the result information of a service provision (containing provisions of goods or other contents) by the volunteer activity, in a storage area over said network in relation to the provider information and a service provision desired condition of a service provider having made said service provision, and
an introduced candidate selecting step at which said information processing device for the coordinator responds to a site providing offer of a site of the business activity from an activity supporter, to select from the service provision desired condition stored in said storage area, individual service providers who provide the service provision desired condition satisfying at least a portion of the contents of said site providing offer, as introduced candidates for said activity supporters and to output the introduced candidate list containing said service provision desired condition and said result information of the individual introduced candidates selected, to said coordinator information processing device.

8. A volunteer activity/business activity supporting method according to claim 7, further comprising:
a step at which said information processing device for the coordinator, which received the output of said introduced candidate list, accepts selection of the service provider to be introduced to said activity supporter from said introduced candidates and outputs at least said service provision desired condition of said service provider selected to said information processing device for the activity supporter.

9. A volunteer activity/business activity supporting method according to claim 7,
wherein said result information is the skill information which is determined according to an evaluation of the quality of the service which is received from said service provider by the service use applicant of the volunteer activity.

10. A supporting method for supporting a coordinator so that a service provider along the desire of an activity supporter for providing a site of a business activity may be introduced to said activity supporter by using a network system connected with various information processing devices through a network, comprising:
a skill information storing step at which an information processing device for a coordinator stores the skill information on the quality of a service provision (containing provisions of goods or other contents) by the volunteer activity, in a storage area over said network in relation to the provider information and a service provision desired condition of a service provider;
an introduced candidate selecting step at which said information processing device for the coordinator responds to a site providing offer of a site of the business activity from an activity supporter, to select the individual service providers having the service provision desired condition, out of the service provision desired condition stored in said storage area, satisfying at least a portion of the contents of said site providing offer, as introduced candidates for said activity supporter, and to output the introduced candidate list describing said provider information and said skill information of the individual service providers selected, to said coordinator information processing device; and
a service provider introducing step at which said information processing device for the coordinator accepts selection of the service provider to be introduced to said activity supporter from said introduced candidates described in said introduced candidate list and outputs said provider information of said service provider to an information processing device for an activity supporter.

11. A volunteer activity/business activity supporting method for supporting a volunteer activity and a business activity through a network connected with a plurality of information processing devices, comprising:
an authentication information storing step at which an information processing device for a coordinator stores the authentication information of a service provision (containing provisions of goods or other contents) by the volunteer activity, in a storage area over said network in relation to the provider information and a service provision desired condition of a service provider; and
a step at which said information processing device for the coordinator responds to a site providing offer of a site of the business activity from an activity supporter, to refer to the service provision desired condition stored in said storage area and to output the service provision corresponding to the service provision desired condition satisfying at least a portion of the contents of said site providing offer, together with said authentication information to an information processing device for the activity supporter.

12. An information processing device for a coordinator to support an activity through a network system connected with a plurality of information processing devices through a network, comprising:
means for storing a provider information of a service provider of a volunteer activity, a desired condition for a service provision (containing provisions of goods or other contents) presented by said service provider, and an authentication information of the service provision, in a storage area formed over said network; and
means for responding to a site providing offer of a site of activity from an activity supporter, to refer to the service provision desired condition stored in the storage, thereby to select the service provision satisfying at least a portion of said site providing offer contents and to output said service provision information selected together with the corresponding authentication information of the service provision to said information processing device for the activity supporter.

13. A volunteer activity/business activity supporting method for supporting a coordinator so that a service (containing provisions of goods or other contents) along a desire of an activity supporter which provides a site of a business activity may be introduced to said activity supporter by using a network system having a plurality of information processing devices connected with a network, comprising:
a step at which an information processing device for the coordinator responds to an input of a site providing offer message of a site of the business activity of the activity supporter to give authentication information to said site providing offer messages; and
a step at which at least one of the information processing devices connected with the network verifies the validity of said site providing offer message with said authentication data given.

14. A volunteer activity/business activity supporting method for supporting a volunteer activity and a business activity through a network connected with a plurality of information processing devices, comprising:
an authentication information storing step of storing the authentication information on a service provision (containing provisions of goods or other contents) of the volunteer activity, in a storage area formed over said network in relation to a service provision desired condition; and
a step of responding to a site providing offer of the site of the business activity from an activity supporter, to output the service provision corresponding to the such a service provision desired condition stored in said storage area as satisfies at least a portion of the contents of said site providing offer together with the authentication information of said service provision to the information processing device for said activity supporter.

15. An information processing device for a coordinator to support a volunteer activity and a business activity through a network, comprising:
means for storing authentication information on a service provision (containing provisions of goods or other contents) of the volunteer activity in relation to a service provision desired condition, in a storage area formed over said network; and
means for responding to a providing offer of a site of business activity from an activity supporter, to output a service provision corresponding to the such a service provision desired condition stored in said storage area as satisfies at least a portion of the contents of said site providing offer to the information processing device for the activity supporter.

16. An information processing device according to claim 15,
wherein the means for outputting the service provision to the information processing device for said activity supporter outputs the authentication information of said service provision additionally at the time of outputting said service provision.

17. A program to be executed in an information processing device for a coordinator to support a volunteer activity and a business activity through a network,
wherein said program executes, when read and executed by said information processing device:
a procedure of storing authentication information on a service provision (containing provisions of goods or other contents) of the volunteer activity, in a storage area formed over said network in relation to a service provision desired condition; and
a procedure of responding to a site providing offer of a site of the business activity from an activity supporter, to output the service provision corresponding to the such a service provision desired condition stored in said storage area as satisfies at least a portion of the contents of said site providing offer to the information processing device for said activity supporter.

18. A program to be executed in an information processing device according to claim 17,
wherein the procedure for outputting the service provision to the information processing device of said activity supporter outputs the authentication information of said service provision additionally at the time of outputting said service provision.
